(19) United States
(12) Patent Application Publication
(10) Pub. No.: US 2012/0075338 A1
(43) Pub. Date: Mar. 29, 2012

(54) PROXIMITY INCLUSION ZONE PICKUP SETTINGS FOR DISTRIBUTED CONVERSATIONS

(75) Inventors: Scott Curtis, Durham, NC (US); Michael W. Helpingstine, Cary, NC (US); Andrew V. Phillips, Raleigh, NC (US)

(73) Assignee: LEMI TECHNOLOGY, LLC, Wilmington, DE (US)

(21) Appl. No.: 13/248,846

(22) Filed: Sep. 29, 2011

Related U.S. Application Data
(60) Provisional application No. 61/387,721, filed on Sep. 29, 2010.

(51) Int. Cl. G09G 5/00; G06F 15/16

(52) U.S. Cl. 345/629; 709/204

(57) ABSTRACT

This disclosure relates generally to systems and methods for informing users regarding one or more conversations currently occurring within a geographic area of interest (GOI). In one embodiment, a user device associated with a user obtains conversation data for the GOI from a server computer. The conversation data may indicate a topic of the conversation and a location of the conversation. The user device may then present a visual representation of the GOI to the user. For example, the visual representation may be a map or a viewfinder frame captured by a camera of the GOI. The user device may present one or more visual indicators. At least one visual indicator is presented in association with the visual representation of the GOI in order to represent the topic of the conversation and the location of the conversation.

### RELATED APPLICATIONS

This application claims the benefit of provisional patent application Ser. No. 61/387,721, filed Sep. 29, 2010, the disclosure of which is hereby incorporated herein by reference in its entirety.

### FIELD OF THE DISCLOSURE

The disclosure relates to system and methods for informing users of social interactions.

### BACKGROUND

Humans have a limited ability of gathering information about social interactions currently occurring around them. While humans may become informed that a particular conversation is currently occurring at a particular location, humans generally have to have some direct contact with those involved in the conversation or be provided with some sort of solicitation in order to become aware of conversation they may be interested in joining. Thus, humans generally become aware of the conversations and the subject matter of conversations in a piecemeal fashion. At any given moment of time, people may desire to be informed of the conversations currently occurring around them. Furthermore, it would be desirable to become aware of the subject matter of the conversation in order for the person to determine their level of interest in the conversation without having to have direct contact with those involved in the conversation. However, current social networking media has not provided humans with the ability to perceive the conversation that is currently occurring around them, unless they come across the information by happenstance or through some form of direct contact with the conversation or the parties involved in the conversation.

What is needed then is a mobile communications application that permits users to perceive what conversations are currently occurring within a geographic area. Furthermore, it is desirable to receive information related to the subject matter of the conversations in order to determine an interest level in the conversations.

### SUMMARY

This disclosure relates generally to systems and methods for informing users regarding one or more conversations currently occurring within a geographic area of interest (GOI). Thus, users may become aware of a location for a conversation currently occurring within the GOI along with a topic for the conversation. In one embodiment, a user device associated with a user obtains conversation data for a geographic area of interest. The user device may then present a visual representation of the GOI to the user. For example, the visual representation may be a map of the GOI or a viewfinder frame captured by a camera of the user device of the GOI. Next, the user device presents one or more visual indicators for the conversation data. The visual indicators are presented so that the visual indicators represent the topic of the conversation and the location of the conversation indicated by the conversation data. In this manner, the user may become aware of the location of the conversation and the topic of the conversation to determine their level of interest in the conversation.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates one embodiment of a system according to one embodiment of the present disclosure.

FIGS. 1A-1D are block diagrams illustrating embodiments of user devices illustrated in FIG. 1.

FIG. 2A illustrates one embodiment of a conversation currently occurring between users of a personal computer.

FIG. 2B illustrates another embodiment of a conversation currently occurring between the users of the personal computer.

FIG. 2C illustrates yet another embodiment of a conversation currently occurring between users of mobile communication devices that form an ad-hoc network.

FIG. 2D illustrates still another embodiment of a conversation currently occurring between users of mobile communication devices engaged in a telephone call.

FIG. 2E illustrates still yet another embodiment of a conversation currently occurring between users of mobile communication devices that form an ad-hoc network and another user of a mobile communication device connected via a telephone call to one of the mobile communication devices in the ad-hoc network.

FIG. 2F illustrates yet another embodiment of a conversation currently occurring between users of mobile communication devices that form an ad-hoc network and other users of mobile communication devices that form another ad-hoc network.

FIG. 2G illustrates still yet another embodiment of a conversation currently occurring between users of mobile communication devices that form the ad-hoc network and other users of mobile communication devices that form the other ad-hoc network.

FIG. 2H illustrates still yet another embodiment of a conversation currently occurring between users of mobile communication devices that are connected via a telephone call.

FIG. 2I illustrates still another embodiment of a conversation currently occurring between users of a personal computer and users of mobile communication devices that form an ad-hoc network.

FIG. 3 illustrates one embodiment of exemplary procedures in accordance with this disclosure.

FIG. 4A illustrates one embodiment of a geographic area of interest (GOI) wherein a location of interest is a current location of a user.

FIG. 4B illustrates another embodiment of a GOI wherein a location of interest does not include a current location of the user.

FIG. 5A illustrates one embodiment of a visual representation of the GOI in FIG. 4A.

FIG. 5B illustrates another embodiment of a visual representation of the GOI in FIG. 4A.

FIG. 5C illustrates still another embodiment of a visual representation of the GOI in FIG. 4A.

FIG. 5D illustrates an embodiment of a visual representation of the GOI in FIG. 4B.

FIG. 5E illustrates another embodiment of a visual representation of the GOI in FIG. 4B.

FIG. 6A illustrates embodiments of the exemplary procedures described above in FIG. 3 and other related exemplary procedures.

FIG. 6B illustrates embodiments of the exemplary procedures described above in FIG. 3 and other related exemplary procedures.

FIG. 6C illustrates an embodiment of the exemplary procedures described above in FIG. 3 and other related exemplary procedures.

FIG. 6D illustrates embodiments of the exemplary procedures described above in FIG. 3 and other related exemplary procedures.

FIG. 6E illustrates embodiments of the exemplary procedures described above in FIG. 3 and other related exemplary procedures.

FIG. 7 illustrates another embodiment of a GOI.

FIG. 8A illustrates one embodiment of a visual representation of the GOI in FIG. 7.

FIG. 8B illustrates one embodiment of a visual representation for a GOI.

FIG. 9A illustrates embodiments of the exemplary procedures described above in FIG. 3 and other related exemplary procedures.

FIG. 9B illustrates embodiments of the exemplary procedures described above in FIG. 3 and other related exemplary procedures.

FIG. 10 illustrates one embodiment of a server computer for the system shown in FIG. 1.

FIG. 11 illustrates one embodiment of a user device for the system shown in FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

This disclosure relates generally to systems and methods of informing users of conversations currently occurring within a geographic area of interest (GOI). To provide the user with information regarding a conversation, a user device associated with the user may be configured to obtain conversation data for a conversation currently occurring within the GOI. The conversation data may indicate a topic of the conversation and a location of the conversation. The user device presents a visual representation of the GOI to the user. At least one visual indicator may be presented in association with the visual representation of the GOI. The visual indicator(s) represent the topic of the conversation and the location of the conversation. The visual representation may be any representation that visually represents the GOI to the user. For example, the visual representation may be a map or a viewfinder frame presented to the user by the user device or some other media based on GOI such as an image tagged with the location data. As explained below, the visual indicators may be a textual representation of the topic of the conversation, location markers, coordinate system information, and/or the like.

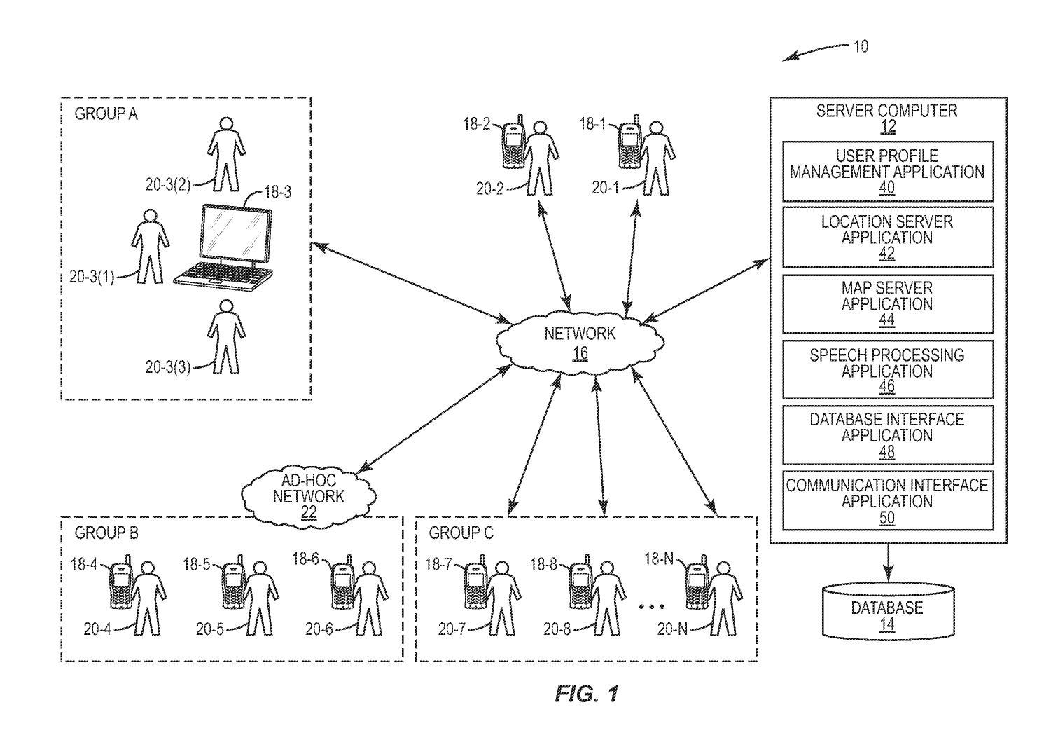

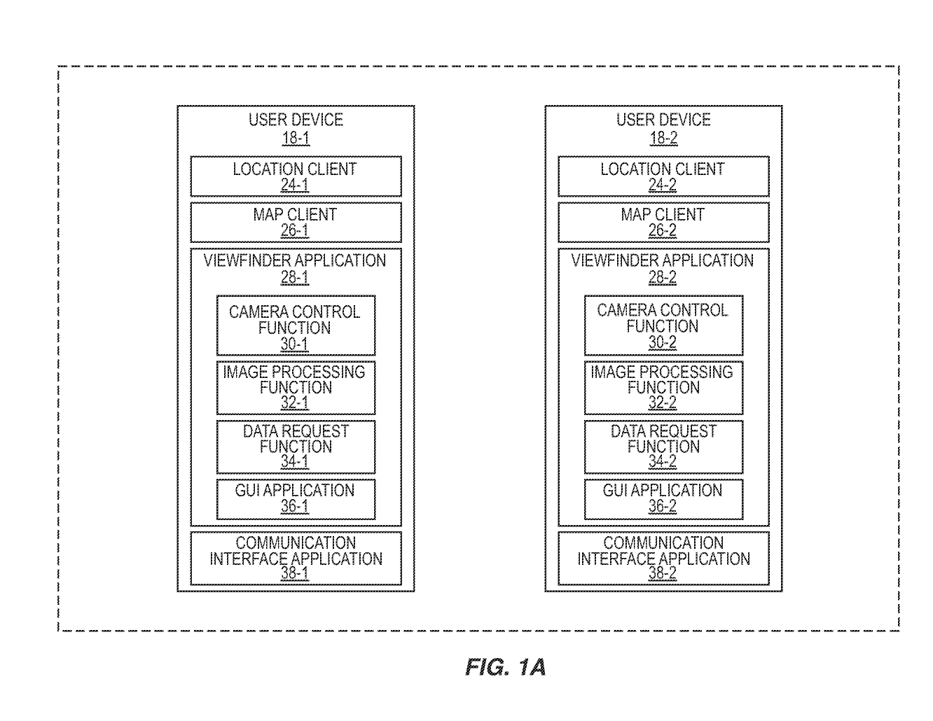

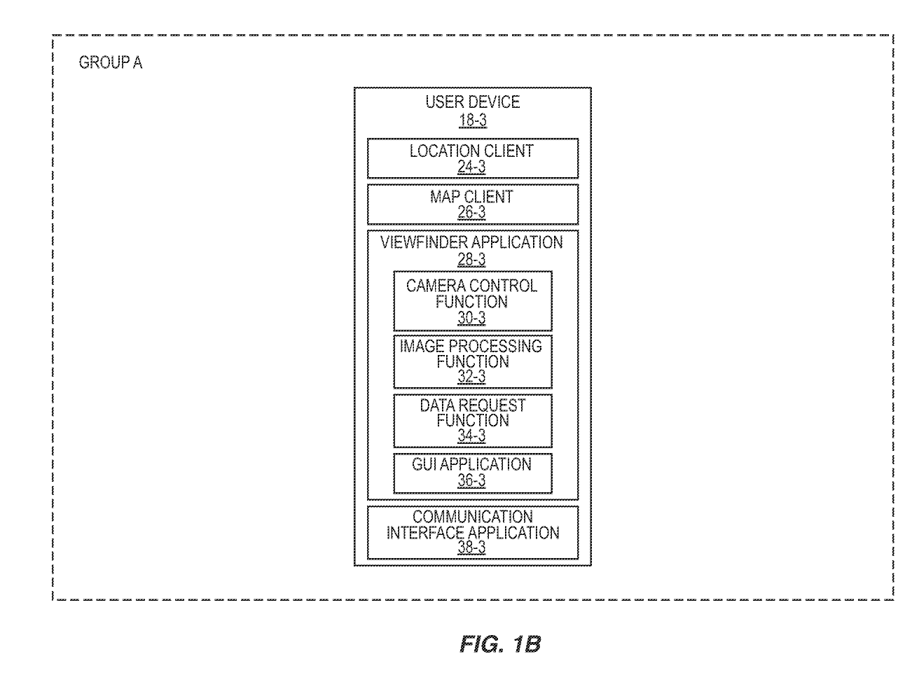

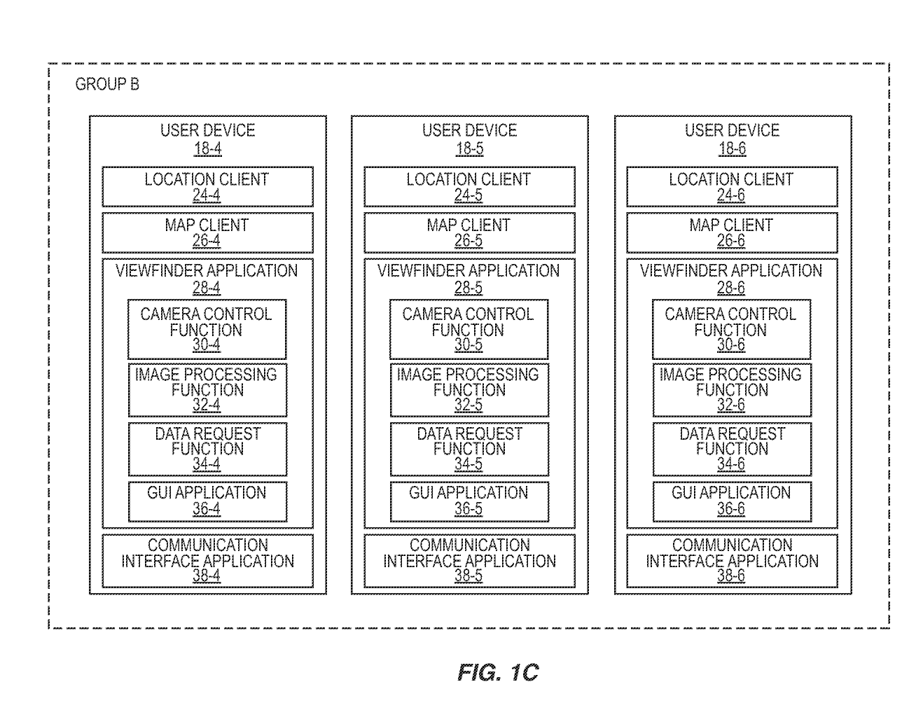

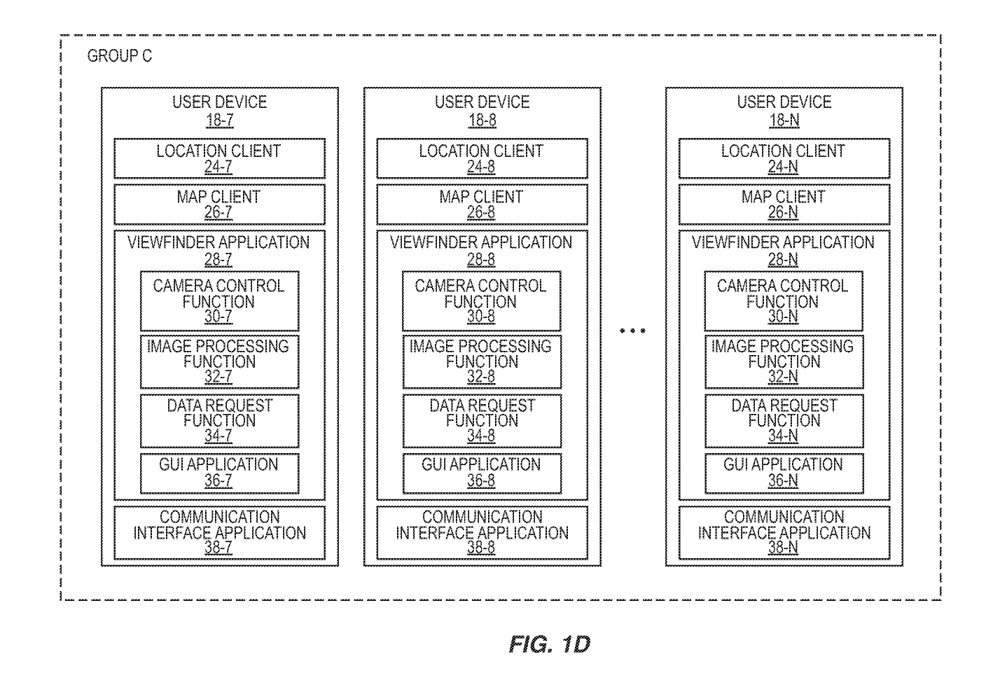

FIG. 1 illustrates a system 10 according to one embodiment of the present disclosure. A general description of the components of the system 10 is provided prior to discussing the details of different implementations of the system 10. In the embodiment, the system 10 includes a server computer 12, a database 14 operably associated with the server computer 12, a network 16, and a plurality of user devices, which are referred to generically with reference number 18 and individually with reference numerals 18-1 through 18-N. The user devices 18 may be communicatively coupled to the server computer 12 through the network 16. Furthermore, the plurality of user devices 18 may each be associated with one or more users, which are referred to generically with reference numeral 20 and individually with reference numerals 20-1 through 20-N. The network 16 may be any type of network or any combination of networks. For example, the network 16 may include a distributed public network such as the Internet, one or more local area networks (LAN), one or more mobile communication networks, one or more ad-hoc networks, such as ad-hoc network 22, and/or the like. If the network 16 includes various types of networks, the network may include gateways or the like to permit communication between the different networks. Also, the network 16 may include wired components, wireless components, or both wired and wireless components.

The user devices 18 may be any type of user device capable of providing the desired functionality in order to implement a particular embodiment of the system 10. For example, the user devices 18 may be personal computers, mobile communication devices, and/or the like. The user device 18-3 in FIG. 1 is a personal computer such as a desktop computer or a laptop. User devices 18-1, 18-2, and 18-4 through 18-N may be mobile communication devices such as mobile smart phones, portable media player devices, mobile gaming devices, tablets, handheld computers, and/or the like. Some exemplary mobile communication devices that may be programmed or otherwise configured to operate in accordance with this disclosure are the Apple® iPhone, Apple® iPad, Apple® iPod Touch® device, a smart phone programmed to have Google's Android operating system, Palm Pre, Samsung Rogue, and Blackberry Storm. Note, this list is simply illustrative and is not intended to limit the scope of the present disclosure. The user devices 18 may connect to the network 16 through ethernet connections, local wireless connections (e.g., Wi-Fi or IEEE 802.11 connections), wireless telecommunications connections (e.g., 3G or 4G telecommunications connections such as GSM, LTE, W-CDMA, or WiMAX connections), and/or the like. This may depend on the communicative features and functionality provided by a particular embodiment of the user devices 18.

As discussed below in further detail, the server computer 12 operates to gather information related to users 20 and the user devices 18. The information gathered by the server computer 12 is stored on the database 14 in database records. In addition, the server computer 12 processes different user device requests from the user devices 18 and provides information to the user devices 18 that are responsive to the request. The server computer 12 may also be operable to formulate search queries to obtain the information from the database 14 so that the server computer 12 can respond to these requests.

In FIG. 1, the database 14 stores information, such as user profiles of the users 20, map data, and conversation data, within database records stored by the database 14. The server computer 12 may forward information to the database 14 for storage in the database records. The server computer 12 may also send information from the database records to devices on the network 16, such as user devices 18.

Referring now to FIG. 1 and FIGS. 1A-1D, FIGS. 1A-1D illustrate block diagrams for embodiments of user devices 18-1 through 18-N. FIG. 1A illustrates block diagrams for the user device 18-1 associated with user 20-1 and the user device 18-2 associated with user 20-2. Users 20-1 and 20-2 are assumed to be searching for conversations within a GOI, while users 20-3 through 20-N are assumed to be engaged in one or more conversations. This arrangement has been selected strictly for the purposes of explaining the concepts related with this disclosure. Each of the user devices 18 in FIG. 1 may be capable of both searching for conversations within the GOI and each of the users 20 may be capable of engaging in one or more conversations. As a result, any combination of the one or more user devices 18 may be searching for conversations within the GOI and any combination of the users 20 may be engaged in one or more conversations. In other embodiments, only some of the user devices 18 may be capable of searching for conversations within the GOI and only some of the users 20 may be capable of engaging in one or more conversations. This may depend on the particular capabilities of each of the user devices 18 and/or the particular communicative disposition of each user 20.

FIG. 1B illustrates a block diagram of the user device 18-3, which is associated with users 20-3(1) through 20-3(3). User device 18-3 is a personal computer. User device 18-3 and users 20-3(1) through 20-3(3) have been designated as Group A. FIG. 1C illustrates block diagrams of user devices 18-4 through 18-6. User devices 18-4 through 18-6 are associated with users 20-4 through 20-6, respectively. User devices 18-4 through 18-6 are each mobile communication devices and have formed ad-hoc network 22. User devices 18-4 through 18-6 and users 20-4 through 20-6 have been designated as Group B. FIG. 1D illustrates block diagrams of user devices 18-7 through 18-N. User devices 18-7 through 18-N are associated with users 20-7 through 20-N, respectively, and have been designated as Group C. User devices 18-7 through 18-N are each mobile communication devices and are connected to the network 16 via a cellular communications link. This arrangement has been selected strictly for the purposes of explaining the concepts related with this disclosure. In practice, there may be any number of users 20 like those in Group A that are associated with personal computers distributed throughout the network 16. There also may be any number of users 20 having mobile communication devices that form any number of ad-hoc networks (such as ad-hoc network 22) like those in Group B. In addition, there may be any number of users 20 having mobile communication devices and being engaged in any number of telephone calls on the network 16, like those in Group C. Furthermore, while this embodiment of the system 10 is designed to operate with users 20 in any of Groups, A, B, and C, other embodiments of the system 10 may be designed to operate only with users 20 in one or some sub-combination of Groups A, B, and C.

Referring again to FIGS. 1 and 1A-1D, the user devices 18 each have a location client (referred to generically with reference number 24 and individually with reference numerals 24-1 through 24-N), a map client (referred to generically with reference number 26 and individually with reference numerals 26-1 through 26-N), and a viewfinder application (referred to generically with reference number 28 and individually with reference numerals 28-1 through 28-N). Note, while each of the user devices 18 is illustrated as including the location client 24, the map client 26, and the viewfinder application 28, in other embodiments, some or all of the user devices 18 may not have each of these components. For example, some user devices 18 may simply have a map client 26, while others may have just a location client 24 and a viewfinder application 28. Other user devices 18 may have a map client 26 and a viewfinder application 28 but no location client 24. Furthermore, each user device 18 may have different software versions of the components depending on the technical characteristics of the specific user device 18.

It should be noted that embodiments of different devices, such as the server computer 12 and the user devices 18, are described throughout this disclosure as using software applications to provide certain functionality. As is apparent to one of ordinary skill in the art, any system that can be implemented with software applications has a hardware circuit analog that utilizes hardware circuits specifically configured to provide the same functionality as the software application. Accordingly, this disclosure does not intend to limit the devices described herein to the utilization of software applications to provide the necessary functionality. Instead, the systems of these devices may be implemented using software applications, hardware circuits, or some combination of both software applications and hardware circuits. All of these implementations are considered to be within the scope of this disclosure.

Also, the software applications described in this disclosure are described as if being distinct software applications. This is done for the purpose of clarity but it may or may not necessarily be the case. The software applications may also be partially or fully integrated with one another and/or may be partially or fully integrated as part of one or more other more generalized software applications. These and other alternatives for providing the functionality of the software applications would be apparent to one of ordinary skill in the art in light of this disclosure and are considered within the scope of this disclosure.

Referring again to FIGS. 1 and 1A-1D, the location client 24 of the user devices 18 operates to determine or otherwise obtain location data indicating the current location of the user device 18. The location data may be any type of information capable of identifying a given geographic point in space through a two-dimensional or three-dimensional coordinate system. The location data thus may include geographic coordinates such as latitude-longitude pairs, and a height vector (if applicable), or any other similar information capable of identifying a given physical point in space in a two-dimensional or three-dimensional coordinate system. The location client 24 may obtain location data indicating a current location of the user device 18 either by receiving the location data from another device or by determining the location data and generating the location data. For example, the location data may be Global Positioning System (GPS) data and the location client 24 may be a Global Positioning System (GPS) application provided on the user device 18. On the other hand, the location data may be triangulation data and the location client 24 may be a mobile communications application that receives or generates the location data indicating the current location using triangulation techniques. Note that certain GPS applications also utilize triangulation techniques to more accurately pin point the location of the user after receiving GPS data from a GPS. Thus, the location data indicating the current location may be obtained both by receiving GPS data and then modifying the GPS data in accordance with triangulation techniques in order to generate location data more accurately indicating a current location of the user devices 18. Also, the location client 24 may be an application that operates separately from the map client 26 or may be entirely or partially subsumed within the map client 26.

The map client 26 is operable to present a map that visually represents the GOI to the user. The map is a visual representation that uses symbolic depictions, pre-captured satellite images, or some hybrid combination of symbolic depictions and pre-captured satellite images to represent a geographic area. The map client 26 may also be operable to generate a map data request in order to receive map data from the server computer 12 for a geographic area. In general, map data includes image data or graphical data utilized to represent the map of a geographic area. For example, the map data may be data for the representation of symbolic objects that represent geographic features on the map (such as buildings, roads, fences, borders, etc.) or may be satellite image data of a pre-captured satellite image of the geographic area.

The map client 26 is operable to convert the map data into a visual representation of the map. The map client 26 may be implemented through a web browser or through a graphical user interface (GUI) that presents the map to the user 20. The map data may also include other types of ancillary map data associated with the map, such as for example, street names, building names, location names, boundary information, etc. This other ancillary data may be visually represented in association with the map as visual indicators overlaid on the map or as visual indicators presented concurrently with the map. As explained in further detail below, the map client 26 may also be operable to generate conversation data requests in order to receive conversation data from the server computer 12. Alternatively, the conversation data may be ancillary map data stored with the map data so that the map data request also returns conversation data for the geographic area.

In the embodiments shown in FIG. 1, the user devices 18 may also each include the viewfinder application 28 that operates with a camera built into or externally connected to the user device 18. The viewfinder application 28 is operable to present a stream of viewfinder frames to the user 20 in real time. As images of the geographic area, each viewfinder frame is the visual representation of the geographic area captured by the camera. The viewfinder frames are generally presented on the GUI provided by the user device 18. The precise functionality of the viewfinder application 28 may vary depending on the type of user device 18, camera, and/or web browser. In the embodiments of user devices 18, each viewfinder application 28 includes a camera control function (referred to generically with reference number 30 and individually with reference numerals 30-1 through 30-N), an image processing function (referred to generically with reference number 32 and individually with reference numerals 32-1 through 32-N), a data request function (referred to generically with reference number 34 and individually with reference numerals 34-1 through 34-N), and a GUI application (referred to generically with reference number 36 and individually with reference numerals 36-1 through 36-N).

In general, the camera control function 30 may be operable to control the optical characteristics of the camera. Thus, the camera control function 30 may be utilized to control a field of view (FOV) of the camera. The image processing function 32 may implement various kinds of image processing techniques to digitally process viewfinder frames. The image processing function 32 may thus determine the characteristics of the viewfinder frames presented on the GUI by the GUI application 36 of the viewfinder application 28. For example, the image processing function 32 may be operable to augment the viewfinder frames captured by the camera with computer generated virtual objects. The augmentation of images streams for real-world geographic areas and objects with computer generated virtual objects in real time is often referred to as “augmented reality.” For example, the image processing function 32 may be operable to overlay one or more visual indicators on the viewfinder frames. The viewfinder application 28 includes the data request function 34 operable to generate user device requests for data utilized to augment the viewfinder frames. In the alternative, the viewfinder application 28 may not include the data request function 34 but rather may utilize other software applications (such as a communication interface application 38) on the user device 18 to generate the user device requests.

The data request function 34 may be operable to generate the conversation data request that requests the conversation data for one or more conversations currently occurring within the geographic area from the server computer 12. The image processing function 32 may then overlay one or more visual indicators on the viewfinder frames in accordance with the conversation data in order to augment the viewfinder frames. However, in the alternative or in addition to overlaying one or more visual indicators on the viewfinder frames, one or more visual indicators may simply be presented contemporaneously with the viewfinder frames on the GUI in accordance with the conversation data. The viewfinder application 28 may also include the GUI application 36 operable to generate the GUI and present the viewfinder frames on the GUI of the user device 18.

In addition, the user devices 18 may also include communication interface application 38 (referred to generically with reference number 38 and individually with reference numerals 38-1 through 38-N). The communication interface application 38 operates with one or more communication interface devices to allow the user devices 18 to connect to the network 16. Since the network 16 may be composed of various different types of networks, the communication interface application 38 may be designed to operate with one or more different types of networks depending on the communication interface devices and communicative capabilities provided with the user device 18. For example, desktop computers may have communication interface application 38 that operates with an Ethernet card or a wireless card to allow the desktop computer to connect to the Internet. On the other hand, mobile communication devices may have communication interface application 38 that operates with one or more antennas and a transceiver to allow the mobile communication device to receive different types of wireless communication services from a mobile communications network or to provide communications in an ad-hoc network.

FIG. 1 also illustrates an embodiment of the server computer 12. The server computer 12 includes a user profile management application 40, a location server application 42, a map server application 44, a speech processing application 46, a database interface application 48, and a communication interface application 50. Note that in this embodiment, a single server computer 12 provides the user profile management application 40, the location server application 42, the map server application 44, and the speech processing application 46. Also, in this embodiment, the server computer 12 operates directly with the database 14, which is also located at the same network location as the server computer 12. This is not necessarily the case. In alternative embodiments, some or all of these software applications may be provided by different server computers operating cooperatively. The server computers may be located either at the same network location or at various different network locations distributed throughout the network 16. Each server computer 12 may include a database interface application and a communication interface application. Similarly, various different databases may store the user profiles, the map data, and/or the conversation data, on different databases located either at the same network location or at various different network locations distributed throughout the network 16. Similarly other data related to the user profiles, the map data, and/or the conversation data may be stored in the database records of separate databases. For example, a user profile may be stored on one database while information relevant to the user profile may be stored on another database. Thus, the user profile may include a link to the database record of the other database in order to find the information.

Referring again to FIG. 1, the user profile management application 40 is operable to manage access to the server computer 12 and the user profiles on the database 14. To provide access to the server computer 12, the user profile management application 40 may execute an authentication process that authenticates the user 20 with the server computer 12. For example, authentication may be performed using credentials such as a username and password. The user profile management application 40 may also implement a user profile update process to update the information associated with the user profiles on the database 14.

In one example, the database 14 may be programmed to store all of the given information for a particular user profile in a single database record. However, the database 14 may be structured to maintain database records in accordance with defined database classes or objects in which the information for each user 20 is at least partially distributed among various database records. Accordingly, the user profile may thus be a user database record having pointers (or pointer-to-pointers) that point to memory locations associated with other database records that actually store the information for the particular user 20-1 through 20-N. The user profiles for the users 20 may also include or point to user identification data in order to identify the user 20 associated with a particular user profile. The user identification data may include user log-in name, user identification number, user device identification, and/or the like. The user profile may also include or point to one or more user device identifications that identify the user devices 18 associated with the user 20, location data indicating a current location for the user devices 18 associated with the user 20, demographic information, general interest information, music interest information, movie interest information, conversational interest information, and/or the like.

The location server application 42 obtains the location data indicating the current location of the user devices 18 from the location client 24 of the user device 18. The location server application 42 may also maintain a record of the location data of each of the user devices 18 to keep up with their locations. The location server application 42 may also provide the location data indicating the current location of a user device 18 to the user profile management application 40 to update the user profile. Note that the location clients 24 of the user devices 18 may repeatedly transmit updated location data to the location server application 42 to record changes in the current location of the user devices 18.

The database 14 may also store map data records of the map data wherein each map data record corresponds to a particular geographic area. Each map data record may include symbolic information, topographical information for objects within the geographic area, and/or the satellite image of the geographic area. Other types of ancillary map data may also be stored within the map data record, for example, street names, building names, location names, boundary information, etc. This ancillary map data may include the conversation data for conversations currently occurring within the geographic area that corresponds to the map data record. Alternatively, separate conversation data records of conversation data may be kept by the database 14 wherein each conversation database record corresponds to a particular geographic area.

The map server application 44 is operable to manage map data requests from the map client application, conversation data requests from the map client application, and conversation data requests from the data request function of the viewfinder application. The map server application 44 receives the map data request from the user devices 18 for the map data. The map server application 44 operates to formulate search queries to retrieve map data and/or conversation data from the database 14 that is responsive to the map data request and/or conversation data requests. The map server application 44 provides the search query to the database interface application 48 which then interfaces with the database 14 to retrieve the relevant map data and/or conversation data. The database interface application 48 then receives the map data and/or conversation data from the database 14 and sends the map data and/or conversation data to the appropriate user devices 18.

The speech processing application 46 is operable to provide real-time speech recognition to generate a conversation transcript record resulting from audio data of one or more conversations between the users 20. Note that details are provided below regarding the gathering of audio data and the association of the audio data with a particular conversation by the server computer 12. As is known by one of ordinary skill in the art, the user devices 18 may be operable to convert speech into audio data. This audio data may be transmitted over the network 16 to the server computer 12 and associated with a conversation currently occurring between one or more of the users 20. The audio data is provided to the speech processing application 46 which generates the conversation transcript record of the conversation based on the audio data. One or more keywords from the conversation transcript record may be extracted to indicate the topic of the conversation. In one embodiment, the speech processing application 46 uses a sliding window of the conversation transcript and transmits the sliding window in a query to a database, such as the database 14, or to an external database, such as a Wikipedia database. The words in the sliding window are weighted based on the distribution of the words within encyclopedic information records. The highest or several of the highest words may be selected as keyword(s) indicating the topic of the conversation. The resulting keyword(s) may then be sent by the speech processing application 46 to the database interface application 48 so that the keyword(s) may be stored as conversation data within the appropriate map data record or conversation data record.

In other embodiment, the audio data may be processed within a peer-to-peer network or within the ad-hoc network 22 by one of the user devices 18, such as a moderator, or by each of the user devices themselves. For example, in the ad-hoc network 22, the user device 18-4 may receive and process the audio data for all of the members of Group B. The user device 18-4 may select a keyword from the audio data as the topic of the conversation, in a similar manner as the server computer 12, as explained above. Furthermore, the location data of the user device 18-4 or some centralized location for user devices 18-4, 18-5, 18-6, may be selected to indicate a location of the conversation. The keyword and the location data (as well as other data determined by the user device 18-4) may be the conversation data for the conversation. The user device 18-4 may also determine a geographic participation zone for the conversation, which may be described by one or more parameters. These parameters may also be conversation data for the conversation. The user device 18-4 may broadcast this conversation data so that other users in the surrounding area can perceive that the conversation is currently occurring.

The database interface application 48 is operable to provide the server computer 12 with the ability to interface with the database 14. The communication interface application 50 operates with one or more communication interface devices to allow the server computer 12 to connect to the network 16. Since the network 16 may be composed of various different types of networks, the communication interface application 50 may be designed to operate with one or more different types of networks. For example, if the server computer 12 is an Internet protocol (IP) based server, the communication interface application 50 may be designed to work with communication interface devices that permit the server computer 12 to send and receive TCP/IP packets over the Internet. In addition, the communication interface application 50 may also allow the IP based server to communicate with gateways so that the IP based server can connect to the gateways for receiving information on the mobile communications network.

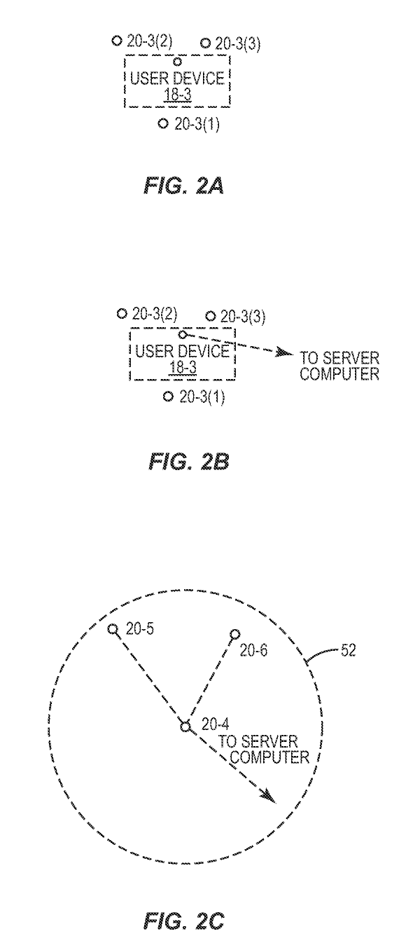

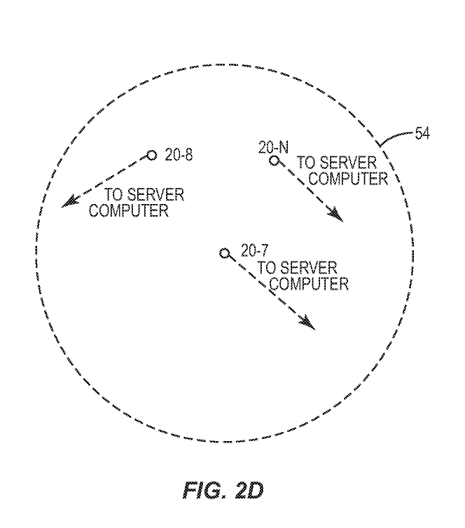

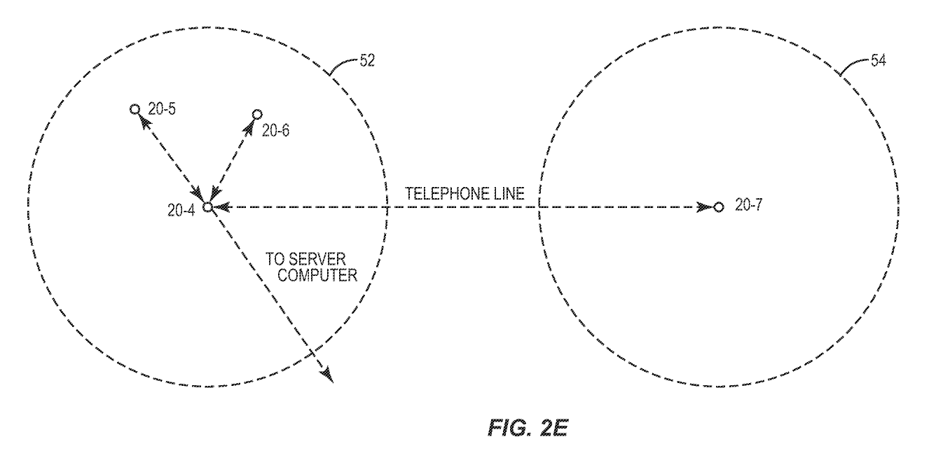

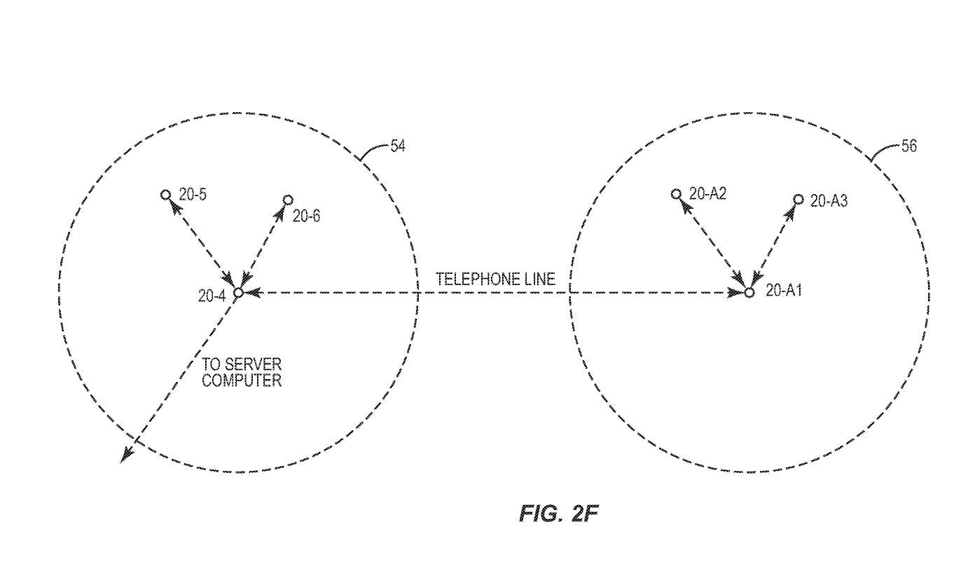

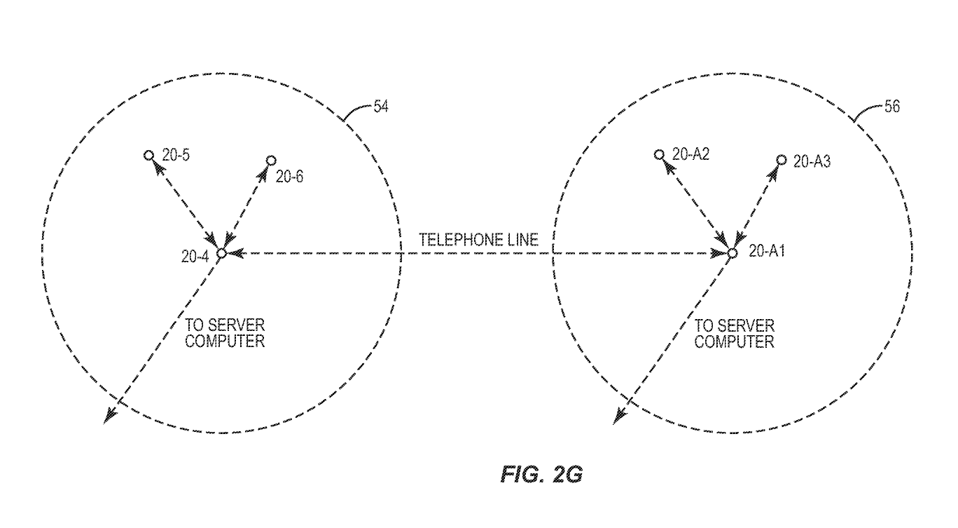

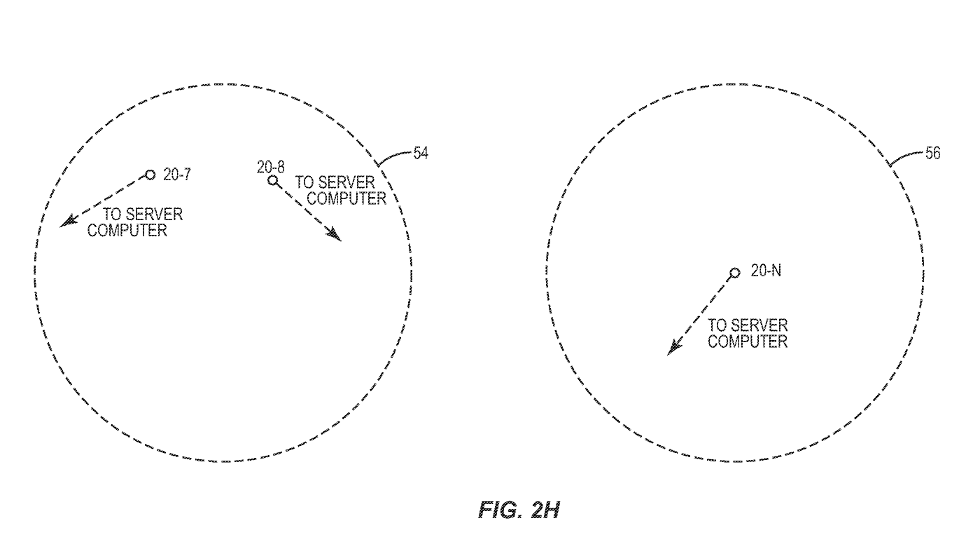

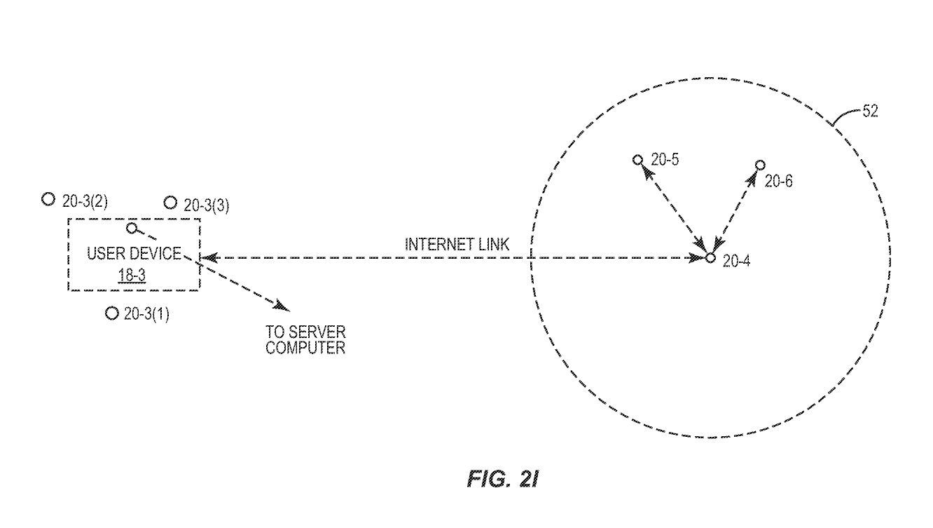

Referring now to FIGS. 1 and 2A-2I, FIGS. 2A-2I illustrate various embodiments of conversations involving the users 20. A conversation is a speech-based communication between two or more users 20. The conversation data for the conversation is any data that describes at least one characteristic of the conversation. For example, the conversation data may indicate various types of information, such as, a topic of the conversation, a location of the conversation, a conversation identifier for identifying the conversation, one or more parameters for defining a geographic participation zone for the conversation, a start time for the conversation, an end time for the conversation, user identifiers for users 20 participating in the conversation, user device identifiers for user devices 18 involved in the conversation, and/or the like. As explained above, this conversation data may be maintained on the database 14 either in the map data records or in separate conversation data records.

FIG. 2A illustrates one example for the conversation, which in this case involves users 20-3(1) through 20-3(3) in Group A. Users 20-3(1) through 20-3(3) are co-located with one another such that audible speech may be interchanged between the users 20-3(1) through 20-3(3). Users 20-3(1) through 20-3(3) are associated with the user device 18-3 by being co-located with the user device 18-3. In one example, a business may sponsor group discussion at their business locale. Prior to the conversation, an acting agent of the business may log the business into the server computer 12 through the user device 18-3. Utilizing the location client 24-3, the business may create a conversation record request that includes user input indicating the topic of the conversation, the start time for the conversation, and the end time for the conversation. The location client 24-3 may then add location data indicating the current location of the user device and send the conversation record request to the location server application 42 on the server computer 12. The location server application 42 recognizes the received information as the conversation record request and forwards the conversation record request to the map server application 44. The map server application 44 then extracts, as conversation data for the conversation, the user input indicating the topic of the conversation and the time for the conversation along with the location data indicating the current location of the user device 18-3. Since the user device 18-3 is located at the business locale, the location data indicates the location of the business. The map server application 44, through the database interface application 48, stores the conversation data with the appropriate map data record in the database 14 or creates a new conversation data record in the database 14 that corresponds to a geographic region that includes the current location of the user device 18-3. In this manner, user devices 18-1 and 18-2 may obtain the conversation data between the start time and the end time so that users 20-3(1) and 20-3(2) can be informed that the conversation is currently occurring at the business locale during the conversation. Note that, in this example, the user device 18-3 is not registered to any of the users 20-3(1) through 20-3(3) but rather to the business entity. Rather, users 20-3(1) through 20-3(3) may simply be customers that decided to participate in the conversation. This demonstrates that the user that is registered with the user device 18-3 may be, but does not necessarily have to be, a participant in the conversation.

FIG. 2B illustrates another example of the conversation. This example also involves the users 20-3(1) through 20-3(3) in Group A. However, in this case, the user device 18-3 has been configured to convert the speech of the conversation into audio data. The user device 18-3, which is a personal computer, may include a microphone that operates with software applications and/or specialized computer cards to convert the speech being exchanged between the users 20-3(1) through 20-3(3) into audio data. In the alternative, the user device 18-3 may be connected to a land-line telephone on speaker mode that converts the speech being exchanged between the users 20-3(1) through 20-3(3) into audio data. The user device 18-3 is operable to transmit the audio data on the network 16 to the server computer 12.

The current location of the user device 18-3 is considered as the location of the conversation. Upon initiation of the speech conversion capabilities of the user device 18-3, the location client 24-3 may be operable to create the conversation record request that includes location data indicating a current location of the user device 18-3 along with the user identification of the business or the user device identification of the user device 18-3. The location client 24-3 sends the conversation record request to the location server application 42 on the server computer 12. The location server application 42 recognizes the conversation record request and forwards the conversation record request to the map server application 44. The map server application 44 then extracts, as conversation data for the conversation, the user identification or user device identification and the location data indicating the current location of the conversation. The conversation data for the conversation is stored in the appropriate map data record or in a new conversation data record that corresponds to the geographic area that includes the location of the conversation. The map server application 44 may forward the user identification of the business (or the user device identification of the user device 18-3) and the location data to the speech processing application 46. In this manner, the speech processing application 46 is configured to listen for the audio data from the user device 18-3.

Once audio data of the conversation is received by the server computer 12, the speech processing application 46 recognizes that the audio data is from the user device 18-3. The speech processing application 46 then extracts the keyword(s) that indicates the topic of the conversation from the audio data. The keyword(s) is sent to the map server application 44 along with the location data and the user identification or user device identification. Using the location data and the user identification or user device identification, the keyword is then stored in the appropriate map data record and/or conversation data record for the conversation. In this manner, user devices 18-1 and 18-2 may obtain the conversation data while the conversation is currently occurring between users 20-3(1) through 20-3(3).

FIG. 2C illustrates still another example of the conversation. This example also involves the users 20-4 through 20-6 in Group A. Each of the users 20-4 through 20-6 is within a geographic participation zone 52 but may or may not be sufficiently close to one another to interchange speech. Since each of the user devices 18-4 through 18-6 is registered on the network 16 with one of the users 20-4 through 20-6, respectively, each of the users 20-4 through 20-6 is associated with one of the user devices 18-4 through 18-6. For example, user device 18-4 is registered with user 20-4. Similarly, a user device 18-5 is registered with user 20-5 and user device 18-6 is registered with user 20-6.

As discussed above, the user devices 18-4 through 18-6 have formed the ad-hoc network 22. Each user device 18-4 through 18-6 generates audio data based on the speech from the corresponding user 20-4 through 20-6 during the conversation which is transmitted along the ad-hoc network 22 to the other user devices 18-4 through 18-6. The ad-hoc network 22 connects the user devices 18-4 through 18-6 wirelessly but locally so that the audio data is directly sent and received from each of the user devices 18-4 through 18-6.

In this example, the user device 18-4 is the moderator of the conversation. Prior to the formation of the ad-hoc network 22, the location client 24-4 has sent a conversation data request to the server computer 12. The conversation record request includes location data indicating the current location of the user device 18-4, one or more parameters that define the geographic participation zone 52 relative to the current location, and the user identifier of the user 20-4 or the user device identifier of the user device 18-4. The location server application 42 recognizes the conversation record request and extracts the location data, one or more parameters that define the geographic participation zone 52, and the user identifier or the user device identifier. The location server application 42 then forwards the conversation record request to the map server application 44. The map server application 44 extracts, as conversation data for the conversation, the user identification or user device identification and the location data indicating the current location of the user device 18-4. In this example, the current location of the user device 18-4 is considered the location of the conversation. The conversation data is stored in the appropriate map data record or in a new conversation data record for the conversation. The user identification or the user device identification and the location data are then forwarded to the speech processing application 46 so that the speech processing application 46 listens for the audio data from the user device 18-4.

In alternative embodiments, the location of the conversation may be considered as the location between the user devices 18-4 through 18-6, such as a calculated center between the user devices 18-4 through 18-6. As user devices 18-4 through 18-6 are associated with the conversation, the location of the conversation may be updated in the appropriate map data record or conversation data record based on location data indicating the current locations of user devices 18-4 through 18-6. On the other hand, the conversation data record requests may be sent to the location server application 42 with location data for the user device 18-5 and/or location data for the user device 18-6, after the formation of the ad-hoc network 22. The current location of the conversation and the geographic participation zone 52 may thus be determined from the location data from each of user devices 18-4 through 18-6.

The location server application 42 may implement a geographic participation zone process. In one embodiment of the geographic participation zone process, the location server application 42 determines the geographic participation zone 52 from the location data and at least one or more parameters that define the geographic participation zone 52 relative to the current location of the conversation. The geographic participation zone 52 defines a geographic region for participating in the conversation. The geographic participation zone 52 may be in any regular or irregular shape. In this embodiment, the one or more parameters is a parameter indicating a radial distance that defines the geographic participation zone 52 as a circular geographic region centered at the location of the conversation. The location server application 42 receives the location data indicating the current location of the user device 18-5 from the location client 24-5. If the location server application 42 calculates that a distance between the user device 18-4 and the user device 18-5 is less than the radial distance, then the user device 18-5 is within the geographic participation zone 52. The location server application 42 then transmits an invitation to the user device 18-5 to join the conversation. The user device 18-5 may then transmit an acceptance of the invitation to the location server application 42. The location server application 42 transmits the acceptance to the user device 18-4, which initiates communications with the user device 18-5 to create the ad-hoc network 22. The user device 18-6 may join the ad-hoc network 22 through the same process.

The audio data may be sent and received by all of the user devices 18-4 through 18-6 on the ad-hoc network. This may enable the users 20-4 to 20-6 to engage in the conversation as the users 20-4 to 20-6 may or may not be within a distance where speech can be exchanged between the users 20-4 to 20-6 without technological assistance. Nevertheless, in this example, the user device 18-4 is the moderator of the conversation. As such, the audio data for the conversation is sent to the server computer 12 by the user device 18-4. Once the audio data of the conversation is received by the server computer 12 via the network 16, the speech processing application 46 recognizes that the audio data is from the user device 18-4. The speech processing application 46 then extracts the keyword(s) that indicates the topic of the conversation from the audio data. The keyword(s) is sent to the map server application 44 along with the location data and the user identifier or user device identifier. Using the location data and the user identifier or user device identifier, the keyword(s) is then stored in the appropriate map data record or the conversation data record for the conversation. In this manner, user devices 18-1 and 18-2 may obtain the conversation data while the conversation is currently occurring between users 20-4 through 20-6 on the ad-hoc network 22.

FIG. 2D illustrates still another example of the conversation. This example also involves the users 20-7 through 20-N in Group C. Each of the user devices 18-7 through 18-N is registered (and, thus associated) on the network 16 with one of the users 20-7 through 20-N. As discussed above, the user devices 18-7 through 18-N are engaged in a telephone call, such as for example a conference call. Each user device 18-7 through 18-N generates audio data based on the speech from the corresponding user 20-7 through 20-N during the conversation which is transmitted along the mobile communications network to the user devices 18-7 through 18-N. Prior to or during the establishment of the telephone call, the location client 24-7 has generated the conversation record request to the server computer 12 at the initiation of the user 20-7. The conversation record request includes location data indicating the current location of the user device 18-7, one or more parameters that define the geographic participation zone 54 relative to the current location, and the user identification of the user 20-7, or the user device identifier of the user device 18-7. The location server application 42 recognizes the conversation record request and extracts the location data, one or more parameters that define the geographic participation zone 54, and the user identifier or the user device identifier. The location server application 42 then forwards the conversation record request to the map server application 44, to provide the conversation data within the appropriate map record or within a new conversation data record.

The geographic participation zone process in this example is similar to the process described above, for FIG. 2C, except that when the user device 18-7 receives the acceptance of the invitation from one of the user devices 18-8 through 18-N, the user device 18-7 initiates the establishment of a communication path through user devices 18-8 through 18-N into the telephone call. In FIG. 2D, there is no moderator to the conversation. In this case, each of user devices 18-7 through 18-N sends its audio data to the server computer 12 independently of the others. As with the other embodiment, the speech processing application 46 receives the audio data to extract the keyword(s) as the topic of the conversation, which may be stored in the appropriate map data record or conversation data record.

FIG. 2E illustrates still yet another example of the conversation. This example also involves the users 20-4 through 20-6 in Group B and one of the users in Group C, user 20-7. In this example, users 20-4 through 20-6 in Group B have been connected to the ad-hoc network 22 as described in FIG. 2C above. However, user 20-7 is not within the geographic participation zone 52 but in the geographic participation zone 54, which is assumed to be at a great distance from the geographic participation zone 52 in this example. The user device 18-7 however allows user 20-7 to take part in the conversation through a telephone call between the user device 18-7 and the user device 18-4. The audio data for the user device 18-7 is transmitted to the user device 18-4, which is a moderator of the conversation. The user device 18-4 passes the audio data from the user device 18-7 received on the telephone call to the user devices 18-5 and 18-6 through the ad-hoc network 22. The user device 18-4 also passes the audio data from the user devices 18-5 and 18-6 on the ad-hoc network 22 to the user device 18-7 through the telephone call. Furthermore, the current location of user device 18-7 may also be considered another location of the conversation. Thus, the conversation may be considered to have multiple locations. Location data from the user device 18-7 indicating the other location of the conversation may also be stored in the appropriate map data record or conversation data record.

FIG. 2F illustrates a further example of the conversation. This example also involves the users 20-4 through 20-6 in Group B and another group of users 20-A1 through 20-A3. The users 20-A1 through 20-A3 are like the users in Group B in that users 20-A1 through 20-A3 are connected through an ad-hoc network 22 formed between their respective user devices. The ad-hoc network 22 associated with the users 20-4 through 20-6 and the other ad-hoc network associated with users 20-A1 through 20-A3 are not local with respect to one another. The geographic participation zone process that forms the other ad-hoc network may be similar to the geographic participation zone process described above in FIG. 2C, except the geographic participation zone is another geographic participation zone 56 and the user device for user 20-A1 is the moderator of the other ad-hoc network. Furthermore, the current location of the user device for the user 20-A1 or a centralized location between users 20-A1 through 20-A3 may also be considered another location of the conversation. The location data indicating the other location of the conversation may also be stored in the appropriate map data record or conversation data record.

The geographic participation zone 54 and the geographic participation zone 56 may be relatively far away. For example, geographic participation zone 54 may be in one city, such as New York, and the geographic participation zone 56 may be in another city, such as Los Angeles. The user device 18-4 however allows the users 20-4 through 20-6 and the users 20-A1 through 20-A3 on both ad-hoc networks to take part in the conversation by establishing a telephone call between the user device 18-4 for user 20-4 and the user device for user 20-A1. The audio data transferred through the telephone call is then distributed by the user device 18-4 for user 20-4 and the user device for user 20-A1 through their respective ad-hoc networks. In this manner, each of the users 20-4 through 20-6 and 20-A1 through 20-A3 can be engaged in the conversation. The audio data for the user device of user 20-A1 is transmitted to the user device 18-4 (which is a moderator of the conversation), which transmits the audio data to the server computer 12.

FIG. 2G is similar to the conversation described in FIG. 2F. In this embodiment, the user device 18-4 is the moderator for ad-hoc network 22 associated with geographic participation zone 54. The user device for the user 20-A1 is the moderator of the conversation associated with geographic participation zone 56. The user device 18-4 sends the audio data for geographic participation zone 54 to the server computer 12. The user device for 20-A1 sends the audio data for geographic participation zone 56 independently to the server computer 12.

FIG. 2H illustrates yet a further example of the conversation. This example also involves the users 20-7 through 20-N in Group C. However, in this example, users 20-7 and 20-8 are in the geographic participation zone 54 while user 20-N is in the geographic participation zone 56. User 20-7 and user 20-8 joined the conversation through the geographic participation zone process described above in FIG. 2D. However, user 20-N is not in geographic participation zone 54 but rather in geographic participation zone 56. In this example, user 20-7 through user device 18-7 conferenced the user device 18-N into the telephone call so that each of the users 20-7 through 20-N could take part in the conversation. Each of the user devices 18-7 through 18-N independently transmits the audio data for the conversation to the speech processing application 46 of the server computer 12. The current location of the user device 18-N may also be considered as the location of the conversation. Thus, location data indicating the other location of the conversation may also be stored with the appropriate map data record or conversation data record.

FIG. 2I illustrates still yet a further example of the conversation. This example also involves the users 20-3(1) through 20-3(3) in Group A and users 20-4 through 20-6 in Group B. Users 20-3(1) through 20-3(3) are part of the conversation and user device 18-3 has sent the conversation record request, as described above for FIG. 2B. The user device 18-4 is considered the moderator of the ad-hoc network 22 and the ad-hoc network 22 has been formed in accordance with the geographic participation zone process described above for FIG. 2C. The current location of the user device 18-3 is considered one location of the conversation while the current location of user device 18-4 may be considered another location of the conversation. Thus, the relevant map data record or conversation data record may store, as conversation data, the location data that indicates both of the locations of the conversation. The one or more parameters defining the geographic participation zone 52 may also be stored as conversation data in the relevant map data record or conversation data record.

The user device 18-3 is the overall moderator of the conversation but is not in the geographic participation zone 52. So that users 20-3(1) through 20-3(3) and users 20-4 through 20-6 may all participate in the same conversation, the user device 18-3 may establish an internet link through the network 16 to the user device 18-4 on the ad-hoc network 22. The audio data from the user device 18-3 and the audio data from the ad-hoc network 22 are exchanged via the internet link so that the users 20-3(1) through 20-3(3) and the users 20-4 through 20-6 may participate in the conversation. As overall moderator, the user device 18-3 transmits all of the audio data to the speech processing application 46 on the server computer 12, which extracts the keyword(s) from the audio data, as conversation data.

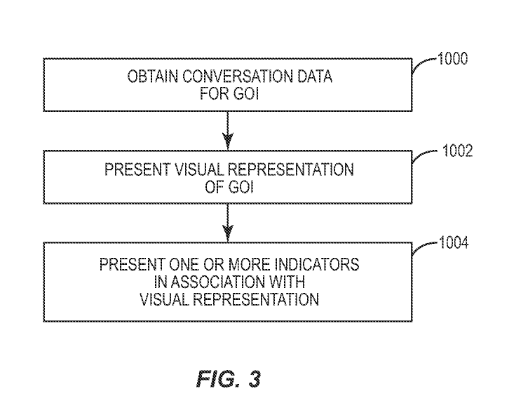

Referring now to FIG. 1 and FIG. 3, FIG. 3 presents exemplary procedures for presenting one or more visual indicators that represent the topic of the conversation and the location of the conversation in association with the visual representation of the GOI. As mentioned above, user 20-1 and user 20-2 are assumed to be searching for conversations within the GOI. The user device 18-1 of the user 20-1 is assumed to be utilized to present one or more visual indicators in association with the map of the GOI. The user device 18-2 is assumed to be utilized to present one or more visual indicators on the viewfinder frame of the GOI. Again, this is a non-limiting arrangement selected simply to help explain the concepts related with this disclosure. Different implementations of the exemplary procedures are discussed below with respect to the user device 18-1 and the user device 18-2. For the sake of simplicity, the exemplary procedures of FIG. 3 are explained with respect to the user device 18-1. Note that the exemplary procedures may be performed in various orders or simultaneously, as noted in the various implementations described below.

To begin, the user device 18-1 obtains conversation data for the GOI from the server computer 12 (procedure 1000). The GOI is the geographic area being presented or that is to be presented on the visual representation. The conversation data indicates the topic for the conversation currently occurring within the GOI and the location of the conversation within the GOI. To indicate the topic of the conversation, the conversation data may include the keyword(s) that indicates the topic of the conversation and has been extracted, for example the speech processing application 46 on the server computer 12, from audio data resulting from the conversation. Alternatively, the conversation data may include user input that indicates the topic of the conversation and created from one of the user devices 18 involved in the conversation. The conversation data may also include location data that indicates the location of the conversation. For example, the conversation data may include GPS data and/or triangulation data that indicate the location of the conversation. The conversation data may also include other information relevant to the conversation, such as the conversation identifier for identifying the conversation, one or more parameters for defining the geographic participation zone for the conversation, the start time for the conversation, the end time for the conversation, user identifiers for users 20 participating in the conversation, user device identifiers for user devices 18 involved in the conversation, the number of participants involved in the conversation, an interest level of the participants of the conversation, an activity level of each of the participants in each of the conversations, an energy level of each of the participants of the conversation, and/or the like. Furthermore, conversation data for any number of conversations may be obtained, which may depend on the number of conversations currently occurring within the GOI.

Next, the user device 18-1 may present the visual representation of the GOI to the user 20-1 (procedure 1002). As mentioned above, the visual representation may be any representation that visually represents the GOI. For user device 18-1, the visual representation is a map. In another example, the visual representation is a viewfinder frame, as with user device 18-2. Other examples that may visually represent the GOI include video frames, photographs, computer drawings, man-sketched drawings, and/or the like. Furthermore, the user device 18-1 may present at least one visual indicator in association with the visual representation (procedure 1004). The one or more visual indicators represent the topic of the conversation and the location of the conversation from the conversation data. The one or more visual indicators may also represent other information, such as for example, a geographic participation zone, the number of participants involved in a conversation, an interest level of the participants, an activity level of the participants, an energy level of the participants, and/or the like. The one or more visual indicators may be presented in association with the GOI either by being overlaid on the visual representation and/or by being presented contemporaneously with the visual representation. Note that various sets of the one or more visual indicators may be presented in association with the visual representation for the conversation data related to multiple conversations currently occurring within the GOI.

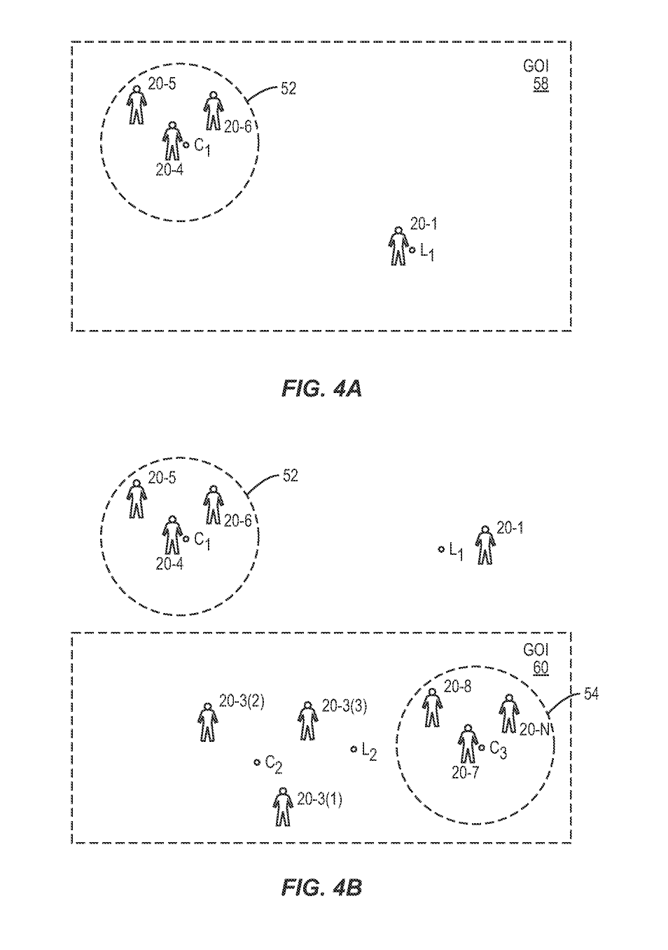

FIG. 4A pictorially illustrates an example of the GOI 58. In this embodiment, the GOI 58 is the real world physical geographic area being or to be represented on a map by the user device 18-1. The user 20-1 and user device 18-1 are at a current location represented by L1. Users 20-4 through 20-6 are currently engaged in a conversation within the geographic participation zone 52, such as the conversation described above for FIG. 2C. The location of the conversation is represented by C1. In FIG. 4A, the location of interest is the current location L1 of the user device 18-1. The user 20-1 is thus within the GOI 58 and the map of the GOI 58 visually represents the GOI 58 so that the user 20-1 can determine the location of conversations around the user 20-1, such as location C1.

As explained in further detail below, the GOI 58 may be determined by the location data indicating the location of interest and one or more map parameters that define the GOI 58 to be or being visually represented on the map. For instance, the map data utilized for the map may be determined by map parameters that determine a relationship between the location of interest, as indicated by the location data, and what the map data is going to be utilized to represent the geographic area on the map at any given moment. Some of these map parameters may include map zoom parameters, map scaling parameters, map data display parameters, and/or the like. As the map corresponds with a real world physical geographic area being visually represented by the map, the GOI 58 may be determined by what is or is not to be represented by the map and a boundary of the GOI 58 may correspond to a boundary of the map. A boundary of the GOI 58 corresponds with a boundary of the map. Thus, the map parameters may also be considered as parameters indicating a boundary of the GOI 58.

FIG. 4B pictorially illustrates another example of a GOI 60. The user 20-1 and user device 18-1 are again at a current location represented by L1. However, in this example, current location L1 is not within the GOI 60. The location of interest L2 may be some other location far from the user 20-1. For example, the user 20-1 may be in New York while the location of interest L2 is in Los Angeles. Users 20-3(1) through 20-3(3) are currently engaged in a conversation, such as the conversation described above for FIG. 2B. The location of the conversation is represented by C2. Users 20-7 through 20-N are also currently engaged in a conversation within the geographic participation zone 54, such as the conversation described above for FIG. 2D. The map of the GOI 60 visually represents the GOI 60 so that the user 20-1 can determine the location of conversations around the location of interest L2, such as locations C2 and C3.

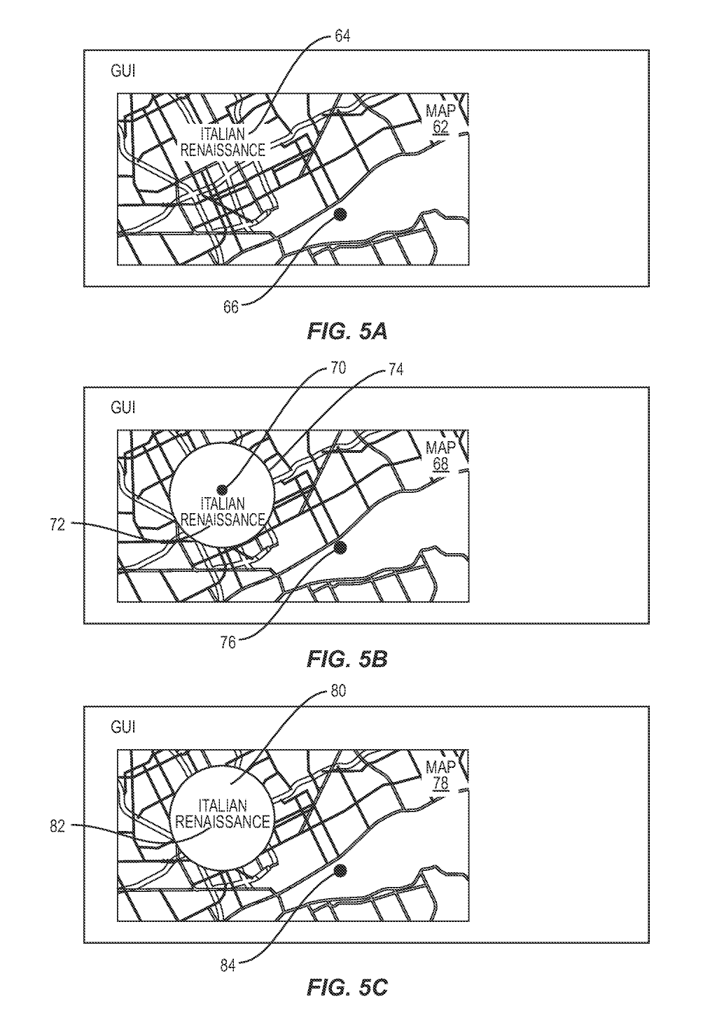

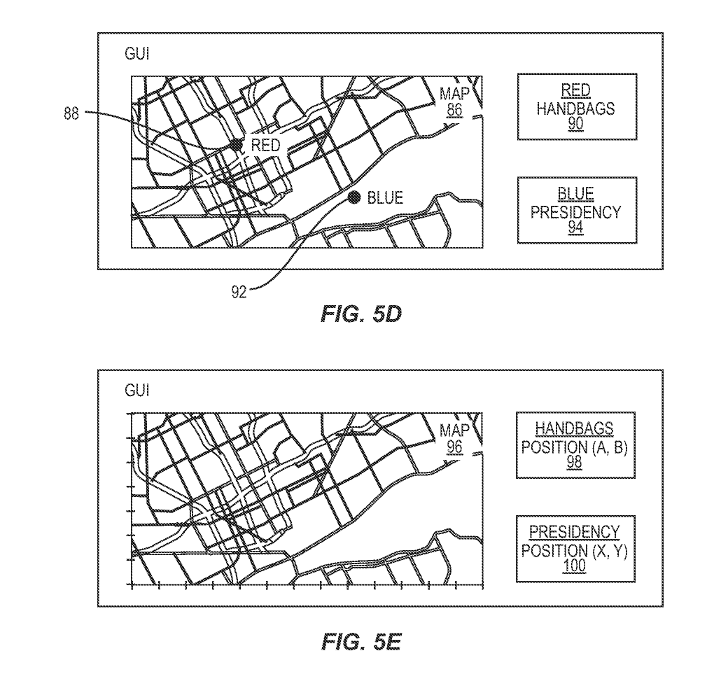

FIG. 5A illustrates one embodiment of map 62 that visually represents the GOI 58 shown in FIG. 4A. The map 62 is being presented in association with the visual indicator 64 and a visual indicator 66 on a GUI executed by the map client 26-1 of the user device 18-1. In this example, the visual indicator 64 and the visual indicator 66 are presented in association with the map 62 by being overlaid on the map 62. The visual indicator 64 is based on the conversation data for the conversation currently occurring at location C1 (shown in FIG. 4A) within the GOI 58 (shown in FIG. 4A). The visual indicator 64 is positioned on the map 62 so as to indicate the location C1 of the conversation. The position of the visual indicator 64 on the map 62 may be based on the location data that indicates the location C1 of the conversation, as provided by the conversation data. The visual indicator 64 in FIG. 5A also simultaneously represents the topic of the conversation. In particular, the visual indicator 64 is presented as the textual representation of the topic of the conversation and in this particular example the textual representation reads “Italian Renaissance.” The visual indicator 64 may be based on keyword(s) or user input indicating the topic of the conversation, as described above. The visual indicator 66 is a location marker positioned on the map 62 so as to indicate the current location L1 (shown in FIG. 4A) of the user device 18-1. The position of the visual indicator 66 on the map 62 may be based on the location data that indicates the location L1 as the current location of the user device 18-1.

FIG. 5B illustrates another embodiment of a map 68 that visually represents the GOI 58 shown in FIG. 4A. The map 68 is being presented in association with a visual indicator 70, a visual indicator 72, a visual indicator 74, and a visual indicator 76 on a GUI executed by the map client 26-1 of the user device 18-1. In this example, the visual indicator 70, the visual indicator 72, the visual indicator 74, and the visual indicator 76 are presented in association with the map 68 by being overlaid on the map 68. The visual indicator 70, the visual indicator 72, and the visual indicator 74 are based on conversation data for the conversation currently occurring at location C1 (shown in FIG. 4A) within the GOI 58 (shown in FIG. 4A). The visual indicator 70 is presented as the location marker that is positioned on the map 68 so as to indicate the location C1 of the conversation. The position of the visual indicator 70 on the map 68 may be based on the location data that indicates the location C1 of the conversation, as provided by the conversation data. The visual indicator 72 in FIG. 5B is presented as the textual representation of the topic of the conversation and is positioned adjacent to the visual indicator 70. The visual indicator 72 may be based on keyword(s) or user input indicating the topic of the conversation, as described above. The visual indicator 74 represents a boundary on the visual representation of the geographic participation zone 52 (shown in FIG. 4A). The visual indicator 74 may be determined based on the location data that indicates the location C1 and on at least one parameter that defines the geographic participation zone 52, such as the radial parameter. The visual indicator 76 is the location marker positioned on the map 68 so as to represent the current location L1 (shown in FIG. 4A) of the user device 18-1. The position of the visual indicator 76 on the map 68 may be based on location data that indicates the location L1 as the current location of the user device 18-1.

By being presented with the map 68 with the visual indicator 74, the user 20-1 can be informed of geographic participation zone 52. The user 20-1 can thus move the user device 18-1 from outside the geographic participation zone 52 into the geographic participation zone 52. When the location client 24-1 transmits updated location data indicating the updated current location of the user device 18-1, the location server application 42 can determine that the user device 18-1 is within the geographic participation zone 52. In response to moving the user device 18-1 into the geographic participation zone 52, the user device 18-1 receives an invitation to join the conversation from the server computer 12. Upon accepting the conversation, the user device 18-1 is connected within the ad-hoc network 22 and the user 20-1 is able to participate in the conversation. The audio data from the user device 18-1 may also be transmitted by the user device 18-4 to the speech processing application 46 on the server computer 12, as described above for user devices 18-5 and 18-6 for FIG. 2C above.

In alternative embodiments, the keywords from the conversation may be stored and tracked for a given user 18 to determine other users 18 that may be interested in the conversation. For example, a user 18 may indicate an interest in a particular topic of conversation. When a conversation related to that topic begins, users 18 interested in the conversation may be sent notifications or invitations to join the conversation. Similarly, if a user 18 indicates an interest in a particular topic, the user 18 may be sent a notification or an invitation when conversation data for a conversation related to that topic is discovered. Keywords from a particular conversation may also be stored and tracked for a given user 18 so as to determine future possible interests in the conversations. In addition, once one of the users 18 has accepted an invitation to join the conversation, other users 18 identified in a contact list (or the like) may be sent notifications or invitations to join the conversation.

FIG. 5C illustrates yet another embodiment of a map 78 that visually represents the GOI 58 shown in FIG. 4A. The map 78 is being presented in association with a visual indicator 80, a visual indicator 82, and a visual indicator 84 on a GUI executed by the map client 26-1 of the user device 18-1. In this example, the visual indicator 80, the visual indicator 82, and the visual indicator 84 are presented in association with the map 68 by being overlaid on the map 68. The visual indicator 80, the visual indicator 82, and the visual indicator 84 are based on conversation data for the conversation currently occurring at location C1 (shown in FIG. 4A) within the GOI 58 (shown in FIG. 4A). The visual indicator 80 is presented as a shaded area that simultaneously represents the location C1 of the conversation and the geographic participation zone 52. Since the position on the map that corresponds to the location C1 within the GOI 58 is included within the shaded area, the visual indicator 80 represents the location C1. In addition, the visual indicator 80 represents the entire geographic participation zone 54 on the map 78 and thereby includes a representation of the boundary of the geographic participation zone 52. The position and area covered by the visual indicator 80 on the map 78 may be determined based on the location data that indicates the location C1 and on at least one parameter that defines the geographic participation zone 52, such as the radial parameter. The visual indicator 82 in FIG. 5C is presented as the textual representation of the topic of the conversation and is positioned within the visual indicator 80. The visual indicator 82 may be based on keyword(s) or user input indicating the topic of the conversation, as described above. The visual indicator 84 is the location marker positioned on the map 78 so as to represent the current location L1 (shown in FIG. 4A) of the user device 18-1. The position of the visual indicator 84 on the map 78 may be based on the location data that indicates the location L1 as the current location of the user device 18-1.

FIG. 5D illustrates an embodiment of a map 86 that visually represents the GOI 60 shown in FIG. 4B. The map 86 is being presented in association with a visual indicator 88, a visual indicator 90, a visual indicator 92, and a visual indicator 94. The visual indicator 88 and the visual indicator 90 are based on conversation data for the conversation at location C2 (shown in FIG. 4B). The visual indicator 92 and the visual indicator 94 are based on conversation data for the conversation at location C3 (shown in FIG. 4B). In this example, the visual indicator 88 and the visual indicator 92 are presented in association with the map 86 by being overlaid on the map 86. On the other hand, the visual indicator 90 and the visual indicator 94 are presented in association with the map 86 by being presented contemporaneously with the map 86.

The visual indicator 88 is presented as the location marker that is positioned on the map 86 so as to represent the location C2 (shown in FIG. 4B). The position of the visual indicator 88 on the map 86 may be based on the location data that indicates the location C2, as provided by the conversation data. In this case, the visual indicator 88 is presented in the color red. The visual indicator 90 in FIG. 5D is presented as the textual representation of the topic of the conversation and is positioned adjacent to the map 86. In this case, the textual representation reads “Handbags” as the topic of the conversation. The visual indicator 90 is also labeled as “Red” to indicate that the visual indicator 88 and the visual indicator 90 are for the same conversation. Alternatively, the visual indicator 90 may simply be presented in the color red. The visual indicator 88 may be based on keyword(s) or user input indicating the topic of the conversation, as described above.

The visual indicator 92 is presented as the location marker that is positioned on the map 86 so as to represent the location C3 (shown in FIG. 4B). The position of the visual indicator 92 on the map 86 may be based on the location data that indicates the location C3, as provided by the conversation data. In this case, the visual indicator 92 is presented in the color blue. The visual indicator 94 in FIG. 5D is presented as the textual representation of the topic of the conversation and is positioned adjacent to the map 86. In this case, the textual representation reads “Presidency” as the topic of the conversation. The visual indicator 94 is also labeled as “Blue” to indicate that the visual indicator 92 and the visual indicator 94 are for the same conversation. Alternatively, the visual indicator 94 may simply be presented in the color blue. The visual indicator 94 may be based on keyword(s) or user input indicating the topic of the conversation, as described above.

FIG. 5E illustrates another embodiment of a map 96 that visually represents the GOI 60 shown in FIG. 4B. The map 96 is being presented in association with a visual indicator 98 and a visual indicator 100. The visual indicator 98 is based on conversation data for the conversation at location C2 (shown in FIG. 4B). The visual indicator 100 is based on conversation data for the conversation at location C3 (shown in FIG. 4B). The visual indicator 98 and the visual indicator 100 are presented in association with the map 96 by being presented contemporaneously with the map 96. In this case, the map 96 includes a coordinate grid that can be utilized to determine the position on the map 96.

The visual indicator 98 in FIG. 5E is positioned adjacent to the map 96. The visual indicator 98 includes the textual representation of the topic of the conversation currently occurring at the location C2 (shown in FIG. 4B) and the textual representation of position coordinates (A, B) corresponding to a position on the map 96. The position coordinates (A, B) represents the location C2 and may be based on location data indicating the location C2. The visual indicator 98 also includes the textual representation for the topic of the conversation currently occurring at the location C2. The visual indicator 98 “Handbags” to represent the topic of the conversation currently occurring at the location C2.

The visual indicator 100 in FIG. 5E is also positioned adjacent to the map 96. The visual indicator 100 includes the textual representation of the topic of the conversation currently occurring at the location C3 (shown in FIG. 4B) and a textual representation of position coordinates (X, Y) corresponding to a position on the map 96. The position coordinates (X, Y) represents the location C3 and may be based on location data indicating the location C3. The visual indicator 100 also includes the textual representation for the topic of the conversation currently occurring at the location C3. The visual indicator 100 reads “Presidency” to represent the topic of the conversation currently occurring at the location C3.

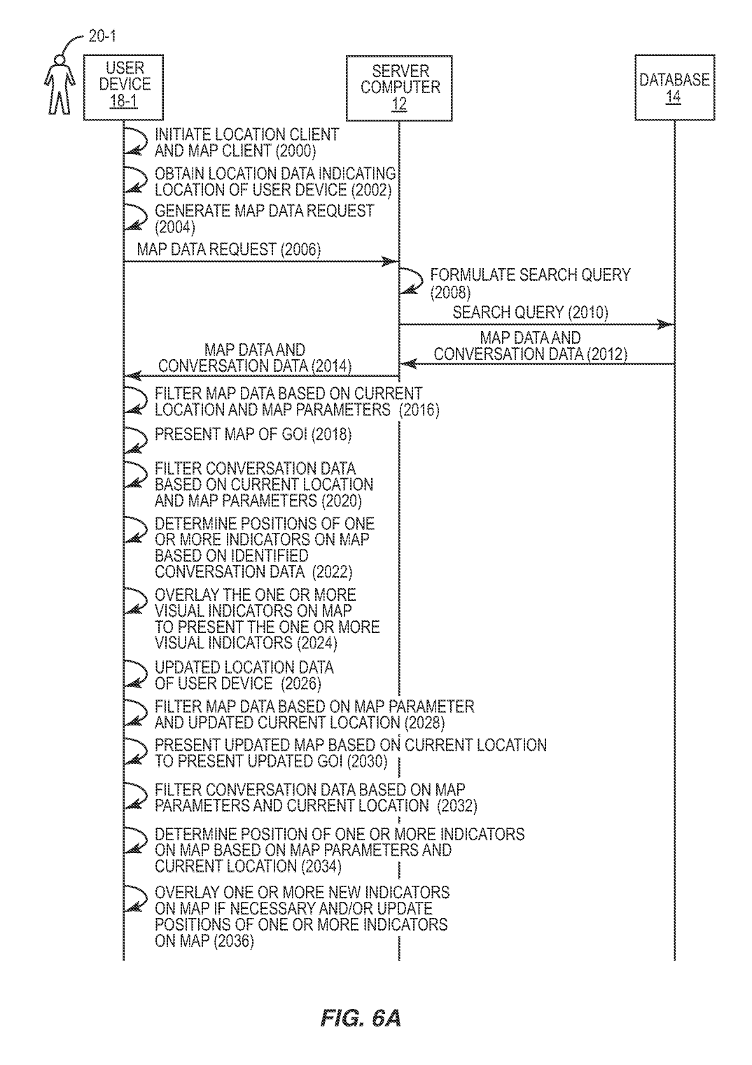

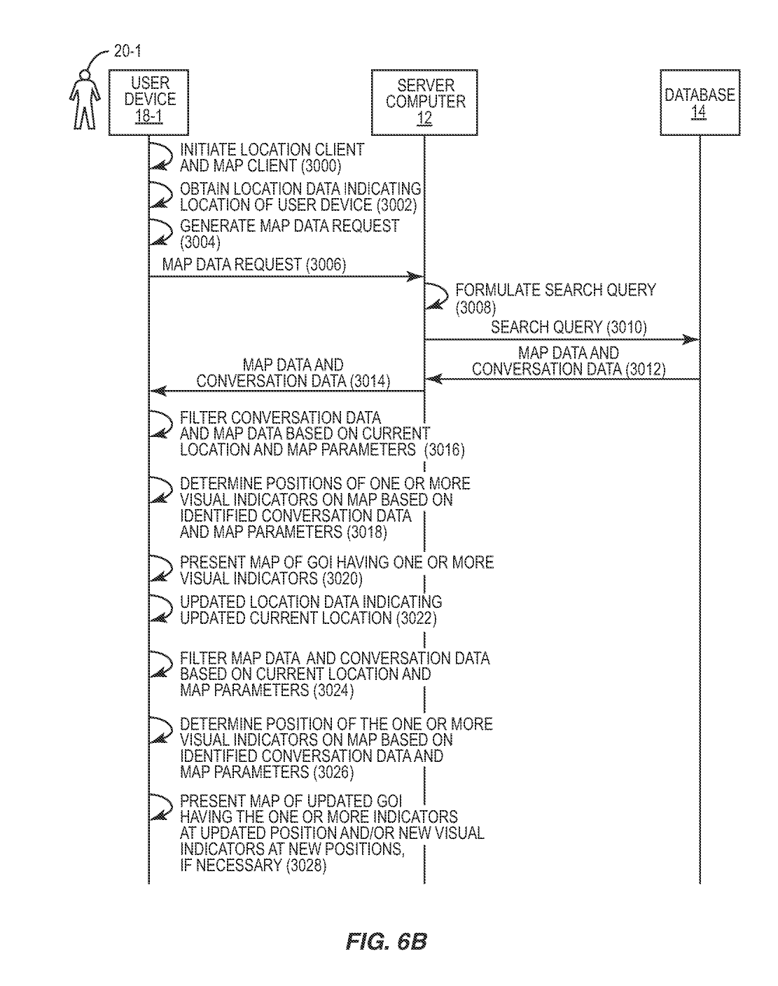

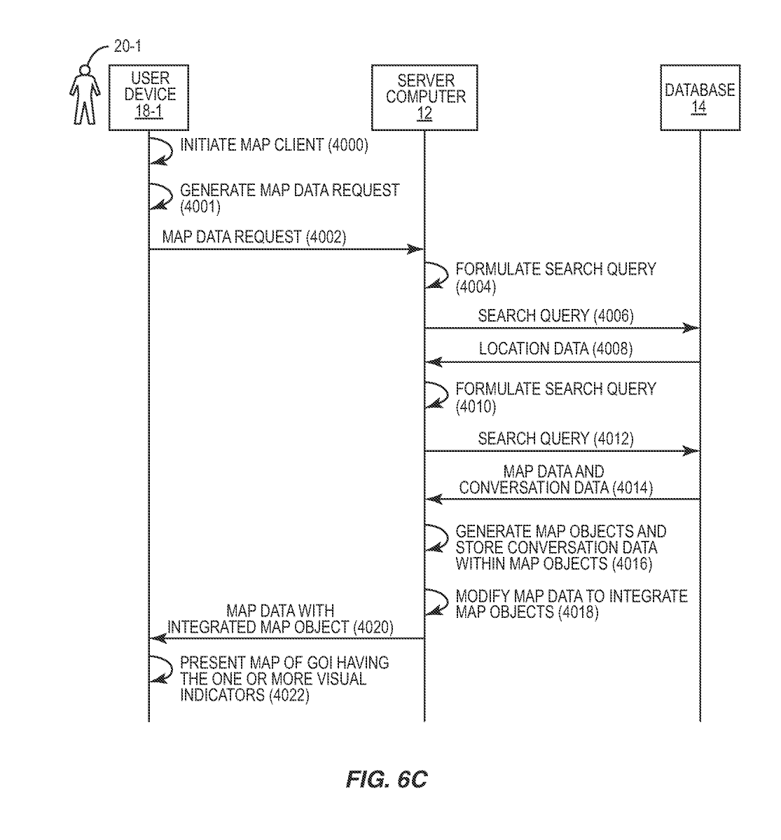

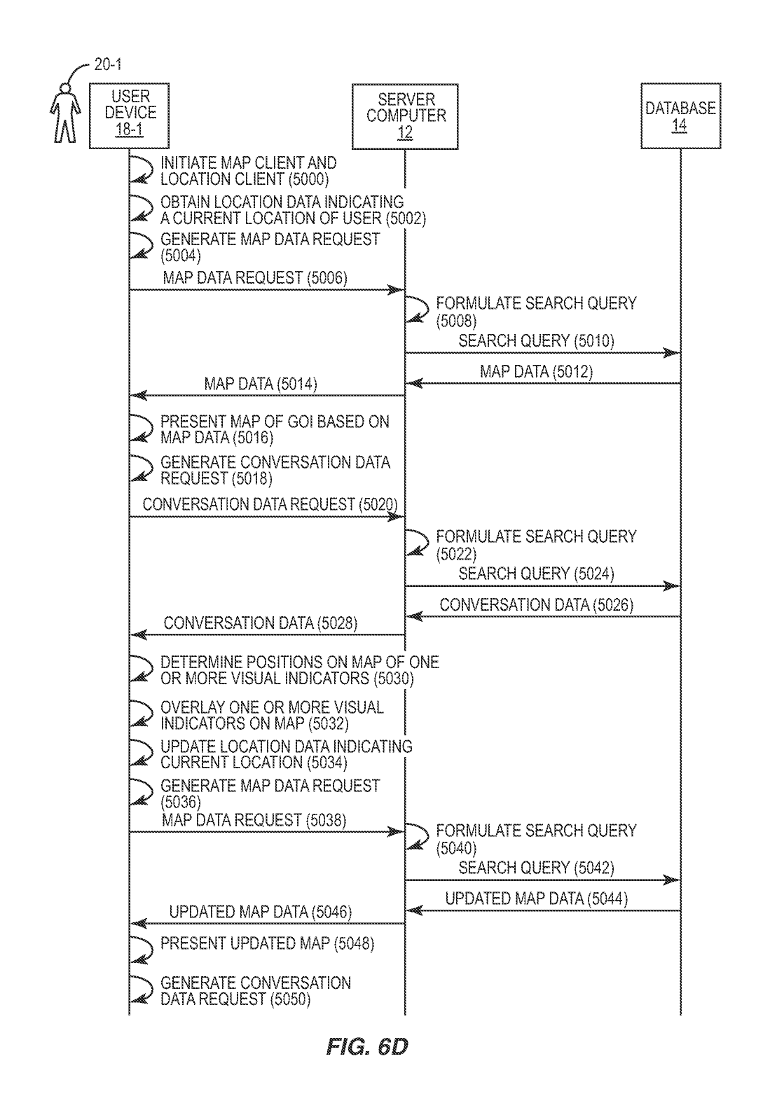

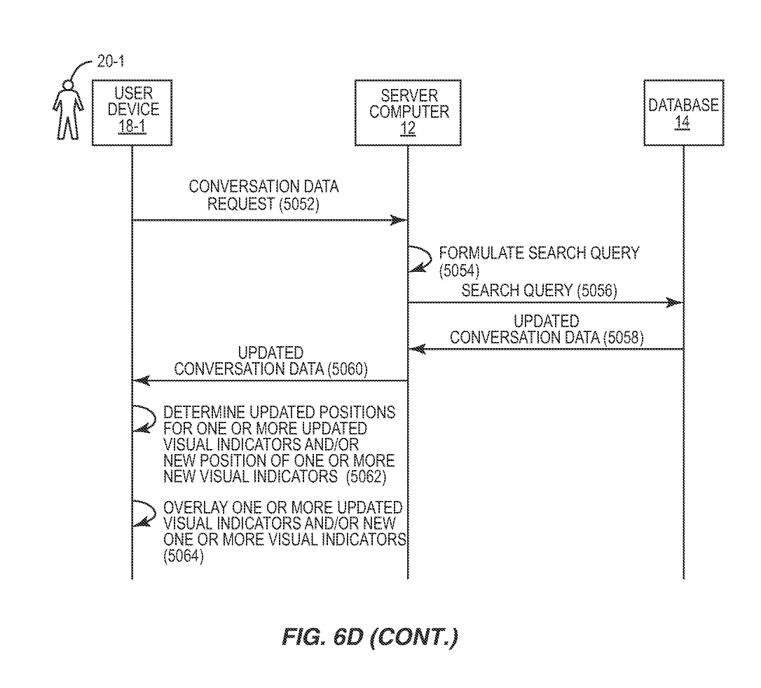

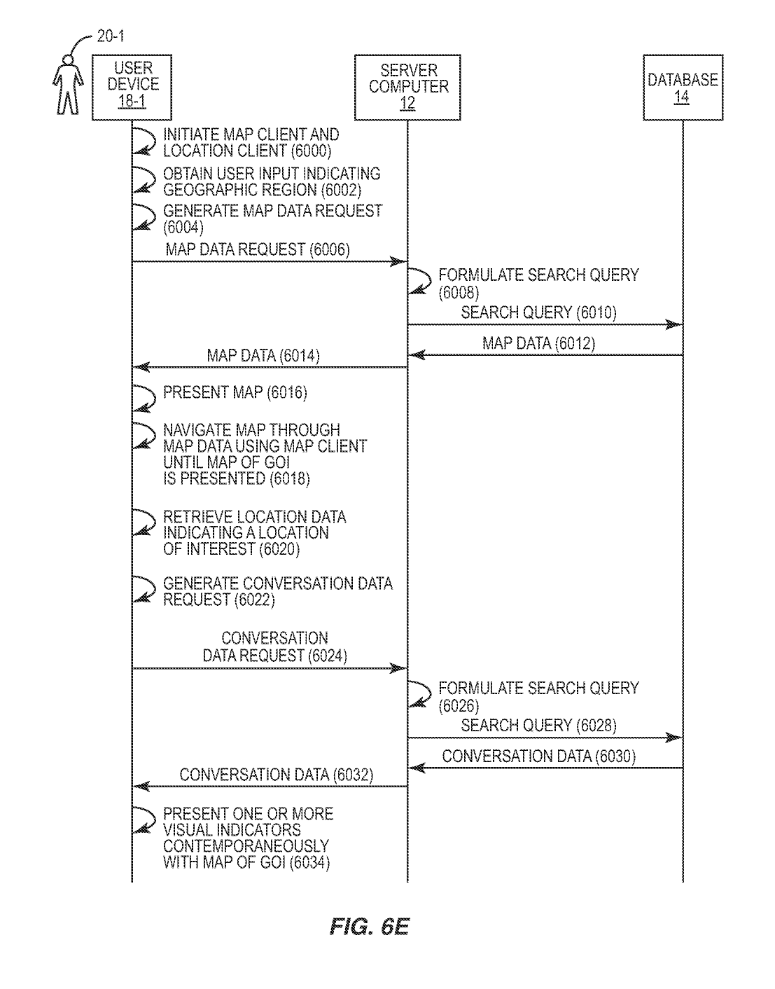

FIG. 6A illustrates embodiments of the exemplary procedures described above in FIG. 3 and other related exemplary procedures. To begin, the user device 18-1 initiates the location client 24-1 and the map client 26-1 (procedure 2000). For example, the user 20-1 may utilize the GUI on the user device 18-1 to select a map client application icon, or the like, that when selected initiates the map client 26-1. This in turn, may automatically initiate the location client 24-1 simultaneously with, concurrently with, and/or as part of the map client 26-1. Alternatively, the user device 18-1 may initiate the location client 24-1 and the map client 26-1 separately. For example, after the map client application icon has been selected by the user 20-1, the user device 18-1 may simply wait until the map client 26-1 has been fully initiated to automatically initiate the location client 24-1. In still another alternative, the user 20-1 may select a separate location client application icon, or the like, that when selected initiates the location client 24-1. The particular manner in which the user device 18-1 initiates the location client 24-1 and the map client 26-1 may depend on the particular implementation of the location client 24-1 and the map client 26-1 provided by the user device 18-1 as well as the characteristics of the user device 18-1.

Next, the user device 18-1 obtains the location data indicating the current location of the user device 18-1 using the location client 24-1 (procedure 2002). In this example, the current location of the user device 18-1 is the location of interest. Afterward, the user device 18-1 generates a map data request for map data (procedure 2004). The map data request includes the location data indicating the current location of the user device 18-1. In this embodiment, the map data request is also the conversation data request for conversation data. To indicate that conversation data is also being requested by the map data request, the map data request may include the conversation indicator and/or may provide the conversation indicator at a particular value indicating that conversation data is also being requested. Alternatively, the server computer 12 may be set up so as to return the conversation data with every map data request or for the map data request from the user devices, such as the user device 18-1 and thus no conversation indicator may be necessary. The map data request may also include other information such as the user identification for user 20-1, the user device identification for user device 18-1, a timestamp, a map type indicator indicating the type of map data desired by the user 20-1, such as for example symbolical map data, topographical map data, satellite map data, and/or the like. The map data request is sent from the user device 18-1 to the server computer 12 (procedure 2006).

Upon receiving the map data request, the map server application 44 reads the map data request, which includes the location data included in the map data request. The map server application 44 then formulates a search query to the database 14 for map data and conversation data that corresponds to the geographic area surrounding the current location indicated by the location data (procedure 2008). In this embodiment, the map server application 44 may not have any information that defines the GOI that is to be presented on the map of the user device 18-1. Nevertheless, the geographic area surrounding the location of interest (in this case, the current location of the user device 18-1) may be large enough so that it necessarily includes any GOI that could be visually represented by the map on the user device 18-1. For example, the user device 18-1 may pre-download map data and conversation data corresponding to a large geographic area to avoid overly repetitive updates. Due to the size of the geographic area, the geographic area surrounding the location of interest must necessarily be greater than and include the GOI to be visually represented on the map. As a result, the conversation data for the geographic area surrounding the location of interest also has to include the conversation data for the GOI.

If the conversation data is included within the map data records, then the search query may simply be for map data, which may automatically result in the return of the conversation data as the ancillary map data. On the other hand, even if the conversation data is included with the map data records, the conversation data may be optional ancillary map data. For example, the map client 26-1 may be configured to allow the user 20-1 to set user settings that determine if the visual indicators for conversation data are to be presented with the map. The conversation indicator in the map data request may indicate that the conversation data is also being requested. The search query may thus include information that indicates that the conversation data should be returned along with the map data.

As discussed above, the map data records and the conversation data records may be maintained on the database separately and thus the search query may also be formulated to search for the map data and the conversation data in separate records. Alternatively, the map server application 44 may formulate separate search queries for the map data and the conversation data, each independently returning the relevant map data and conversation data.

Next, the search query is then forwarded from the server computer 12 to the database 14 (procedure 2010). The database 14 finds the relevant map data records (and the conversation data records if separately maintained) that correspond to the map data and the conversation data of the geographic area surrounding the location of interest, which in this case is the current location of the user device 18-1. The database 14 then forwards the map data and the conversation data to the server computer 12 in response to the search query (procedure 2012).

Next, the user device 18-1 then receives the map data and the conversation data from the server computer 12 (procedure 2014). As a result, the user device 18-1 obtains the map data and conversation data. The map data and conversation data include the map data and conversation data for the GOI, as mentioned above. In this embodiment, the map data for the GOI is identified from the map data for the geographic area surrounding the location of interest prior to presenting the map. To identify map data for the GOI, the map data for the geographic area surrounding the location of interest may be filtered based on the current location of the user device, as indicated by the location data and at least one map parameter that defines a boundary of the GOI to be represented by the map (procedure 2016).

The user device 18-1 may then present the map of the GOI (procedure 2018). In particular, the map client 26-1 may present the map of the GOI through a GUI, or the like. The map is presented by the user device 18-1 in accordance with the identified map data for the GOI resulting from the filtering. In this embodiment, the conversation data for the GOI is identified from the conversation data for the geographic area surrounding the location of interest prior to presenting one or more visual indicators for conversations in association with the map. To identify the conversation data for the GOI, the conversation data for the geographic area surrounding the location of interest may be filtered based on the current location of the user device, as indicated by the location data and at least one map parameter that defines a boundary of the GOI being represented by the map (procedure 2020). As described above, the identified conversation data may include conversation data for one or more conversations currently occurring within the GOI.

In this embodiment, one or more visual indicators are to be overlaid on the map. The user device 18-1, through the map client 26-1, may determine positions of the one or more visual indicators on the map based on the identified conversation data for the GOI (procedure 2022). Based on the positions determined for the one or more visual indicators, the one or more visual indicators are overlaid by the user device 18-1 on the map to present the one or more visual indicators (procedure 2024). In particular, the map client 26-1 may operate with the GUI for the map client 26-1 so as to present the one or more visual indicators at the appropriate positions. Alternatively, the visual indicator(s) may be represented contemporaneously with the map rather than be overlaid on the map. The GUI of the map client 26-1 may determine the manner of presenting the visual indicator(s) based on the conversation data and in accordance with the manner that the GUI of the map client 26-1 is set up to present the conversation data for conversations.

Accordingly, as shown by procedures 2014, 2018, and 2024 in FIG. 6A, the user device 18-1 implements one embodiment of the exemplary procedures discussed above in FIG. 3. Procedure 2014 in FIG. 6A is one implementation of the exemplary procedure 1000 in FIG. 3, procedure 2018 in FIG. 6A is one implementation of exemplary procedure 1002 in FIG. 3, and procedure 2024 in FIG. 6A corresponds to one implementation of exemplary procedure 1004 in FIG. 3. Procedure 2014 is initiated first, procedure 2018 is initiated second, and procedure 2024 is initiated third. Thus, in this embodiment, one embodiment of the exemplary procedure 1000 is initiated first, one embodiment of the exemplary procedure 1002 is initiated second, and one embodiment of the exemplary procedure 1004 occurs third.

Next, the location client 24-1 may provide updated location data indicating an updated current location of the user device 18-1 (procedure 2026). The updated location data may be provided to the map client 26-1. To identify map data for an updated GOI, the map data for the geographic area surrounding the prior current location may be filtered based on the updated current location of the user device, as indicated by the updated location data, and at least one map parameter that defines a boundary of the updated GOI to be represented by an updated map (procedure 2028). The user device 18-1 may then present the updated map of the GOI in accordance with the filtered map data (procedure 2030). To identify conversation data for the updated GOI, the conversation data for the geographic area surrounding the prior current location may be filtered based on the current location of the user device, as indicated by the updated location data, and at least one map parameter that defines a boundary of the updated GOI being represented by the updated map (procedure 2032). The user device 18-1, through the map client 26-1, may determine updated positions of the one or more visual indicators on the map based on the identified conversation data for the GOI and/or new positions for one or more new visual indicators, if there is conversation data for new conversations (procedure 2034). Based on the updated positions determined for the one or more visual indicators, the one or more visual indicators are overlaid at their updated position on the updated map (procedure 2036). In addition, if there are any new visual indicators, the new visual indicators are presented on the updated map at the new positions.

As shown by procedures 2014, 2030, and 2036 in FIG. 6A, the user device 18-1 implements another embodiment of the exemplary procedures discussed above in FIG. 3. Procedures 2014 in FIG. 6A is one implementation of the exemplary procedure 1000 in FIG. 3, procedure 2030 in FIG. 6A is one implementation of exemplary procedure 1002 in FIG. 3, and procedure 2036 in FIG. 6A corresponds to one implementation of exemplary procedure 1004 in FIG. 3. Procedure 2014 is initiated first, procedure 2030 is initiated second, and procedure 2036 is initiated third. Thus, in this embodiment, one embodiment of the exemplary procedure 1000 is initiated first, one embodiment of the exemplary procedure 1002 is initiated second, and one embodiment of the exemplary procedure 1004 occurs third.

FIG. 6B illustrates embodiments of the exemplary procedures described above in FIG. 3 and other related exemplary procedures. Procedures 3000, 3002, 3004, 3006, 3008, 3010, 3012, 3014 in FIG. 6B are analogous to procedures 2000, 2002, 2004, 2006, 2008, 2010, 2012, 2014, respectively, described above for FIG. 6A. However, in this embodiment, the map data and the conversation data for the geographic area surrounding the current location of user device 18-1 are filtered simultaneously based on the current location of the user device, as indicated by the location data, and at least one map parameter that defines a boundary of the GOI to be represented by the map (procedure 3016). In this manner, the map data for the GOI and the conversation data for the GOI are identified simultaneously from the map data and conversation data surrounding the current location of user device 18-1 prior to presenting the map of the GOI and prior to presenting one or more visual indicators in association with the map of the GOI. In this embodiment, one or more visual indicators are to be overlaid on the map. The user device 18-1, through the map client 26-1, may determine positions of the one or more visual indicators on the map based on the identified conversation data for the GOI (procedure 3018). Based on the positions determined for the one or more visual indicators, the user device 18-1 may then present the map having the one or more visual indicators already overlaid on the map (procedure 3020). Thus, in this example, both presenting the map and presenting the one or more visual indicators occurs simultaneously.

Accordingly, as shown by procedures 3014 and 3020 in FIG. 6B, the user device 18-1 implements one embodiment of the exemplary procedures discussed above in FIG. 3. Procedure 3014 in FIG. 6B is one implementation of the exemplary procedure 1000 in FIG. 3, and procedure 3020 in FIG. 6B is one implementation of both exemplary procedures 1002 and 1004 in FIG. 3. Procedure 3014 is initiated first and procedure 3020 is initiated later. Thus, in this embodiment, one embodiment of the exemplary procedure 1000 is initiated first, and one embodiment of the exemplary procedure 1002 and exemplary procedure 1004 occur simultaneously.

Next, the location client 24-1 may provide updated location data indicating an updated current location of the user device 18-1 (procedure 3022). The updated location data may be provided to the map client 26-1. To identify map data and the conversation data for an updated GOI, the geographic area surrounding the previous current location of user device 18-1 are again filtered simultaneously based on the updated current location of the user device, as indicated by the updated location data, and at least one map parameter that defines a boundary of a GOI to be represented by the updated map (procedure 3024). The user device 18-1, through the map client 26-1, may determine updated positions of the one or more visual indicators on the map based on the identified conversation data for the GOI and/or new positions for one or more new visual indicators, if there is conversation data for new conversations (procedure 3026). Based on the updated positions determined for the one or more visual indicators, the user device 18-1 may then present the updated map having the one or more visual indicators already overlaid on the map according to their updated positions (procedure 3028). In addition or alternatively, the updated map may also have any new visual indicators already overlaid on the updated map according to any new positions.

Accordingly, as shown by procedures 3014 and 3028 in FIG. 6B, the user device 18-1 implements another embodiment of the exemplary procedures discussed above in FIG. 3. Procedure 3014 in FIG. 6B is one implementation of the exemplary procedure 1000 in FIG. 3, and procedure 3028 in FIG. 6B is one implementation of both exemplary procedures 1002 and 1004 in FIG. 3. Procedure 3014 is initiated first and procedure 3028 is initiated later. Thus, in this embodiment, one embodiment of the exemplary procedure 1000 is initiated first, and one embodiment of the exemplary procedure 1002 and exemplary procedure 1004 occur simultaneously.

FIG. 6C illustrates an embodiment of the exemplary procedures described above in FIG. 3 and other related exemplary procedures. In this embodiment, location data for a current location of the user device 18-1 may be stored in the database 14 in association with a user profile for the user 20-1. The location data may be reported to the server computer 12 by a node on the network 16 and stored in the database 14 with the user profile. The node on the network 16 may be for example a mobile communications server or a presence server. To begin, the user device 18-1 initiates the map client 26-1 (procedure 4000). In this example, the location client 24-1 may not be initiated, such as for example, if the user device 18-1 did not have the location client 24-1 or if the location client 24-1 is not operable with the map client 26-1. Afterward, the user device 18-1 generates the map data request for the map data and the conversation data (procedure 4001). In this example, the map data request includes the user identification for user 20-1 and one or more map parameters for defining the GOI. If necessary, the conversation indicator may also be included in the map data request. The map data request is then sent from the user device 18-1 to the server computer 12 (procedure 4002).

Utilizing the user identification, the server computer 12 may formulate a search query to find location data indicating a current location of the user device 18-1 (procedure 4004). The search query is then forwarded to the database 14 (procedure 4006). In response to the search query, the database 14 may locate the user profile for user 20-1 and extract the location data indicating the current location of the user device 18-1 from the user profile. The location data is then forwarded to the server computer 12 (procedure 4008).

Once the server computer 12 obtains the location data, the server computer 12 formulates another search query (procedure 4010). The search query is for the map data and the conversation data for the GOI. The search query may be based on the current location of the user device 18-1, as indicated by the location data, and one or more map parameters that define the GOI. The search query is then forwarded to the database 14 (procedure 4012). In response to the search query, the database 14 may locate the map data and the conversation data that correspond to the GOI. The map data and the conversation data are then forwarded to the server computer 12 (procedure 4014). Note that, in this embodiment, the map data and the conversation data is specifically for the GOI. Thus, filtering may not be necessary.

The map data may include various map objects that include computer graphics data for visually representing geographic features through computer graphics. The map objects may be configured with a particular GUI that is executed by the map client 26-1 of the user device 18-1. The map server application 44 may generate one or more map objects and store the conversation data within these generated map objects (procedure 4016). The map server application 44 may then modify the map data to integrate the map objects into the map data (procedure 4018). The user device 18-1 receives the map data with the integrated map objects from the server computer 12 (procedure 4020). In this manner, the user device 18-1 obtains the conversation data. The user device 18-1 presents the map of the GOI that has one or more visual indicators that represent the conversations (procedure 4022). In particular, the map objects instruct the GUI of the map client 26-1 to present the one or more visual indicators as computer graphics on the map. The position of the one or more visual indicators on the map, as well as textual representations of keyword(s) or user input, may be based on the conversation data within the map objects that were integrated into the map data. Thus, in this example, both presenting the map and presenting the one or more visual indicators occurs simultaneously.

Accordingly, as shown by procedures 4020 and 4022 in FIG. 6C, the user device 18-1 implements one embodiment of the exemplary procedures discussed above in FIG. 3. Procedure 4020 in FIG. 6C is one implementation of the exemplary procedure 1000 in FIG. 3, and procedure 4022 in FIG. 6C is one implementation of both exemplary procedures 1002 and 1004 in FIG. 3. Procedure 4020 is initiated first and procedure 4022 is initiated later. Thus, in this embodiment, one embodiment of the exemplary procedure 1000 is initiated first, and one embodiment of the exemplary procedures 1002 and exemplary procedure 1004 occur simultaneously.

FIG. 6D illustrates embodiments of the exemplary procedures described above in FIG. 3 and other related exemplary procedures. To begin, the user device 18-1 initiates the location client 24-1 and the map client 26-1 (procedure 5000). Next, the user device 18-1 obtains location data indicating a current location of the user device 18-1 using the location client 24-1 (procedure 5002). In this example, the current location of the user device 18-1 is the location of interest. Afterward, the user device 18-1 generates the map data request for the map data (procedure 5004). The map data request includes the location data indicating the current location of the user device 18-1 and one or more map parameters that define the GOI. The map data request is sent from the user device 18-1 to the server computer 12 (procedure 5006).

Upon receiving the map data request, the map server application 44 reads the map data request, which includes the location data and the one or more map parameters that define the GOI. The map server application 44 then formulates a search query to the database 14 for the map data that corresponds to the GOI based on the location data and the one or more map parameters that define the GOI (procedure 5008). Next, the search query is then forwarded from the server computer 12 to the database 14 (procedure 5010). The database 14 finds the relevant map data records that correspond to the map data for the GOI. The database 14 then forwards the map data to the server computer 12 in response to the search query (procedure 5012). The user device 18-1 then receives the map data from the server computer 12 (procedure 5014). Note that, in this embodiment, the map data is specifically for the GOI. Thus, filtering of the map data may not be necessary. The user device 18-1 presents the map of the GOI based on the map data (procedure 5016).

Next, the user device 18-1 generates the conversation data request for conversation data (procedure 5018). The conversation data request includes the location data indicating the current location of the user device 18-1 and one or more map parameters that define the GOI. The conversation data request is sent from the user device 18-1 to the server computer 12 (procedure 5020). Note that, in this embodiment, the map data request and the conversation data request are separate requests. Thus, the conversation indicator may not be necessary.

Upon receiving the conversation data request, the map server application 44 reads the conversation data request, which includes the location data and the one or more map parameters that define the GOI. The map server application 44 then formulates a search query to the database 14 for conversation data that corresponds to the GOI based on the location data and the one or map parameters that define the GOI (procedure 5022). Next, the search query is then forwarded from the server computer 12 to the database 14 (procedure 5024). The database 14 finds the relevant map data records or the conversation data records having the conversation data for the GOI. The database 14 then forwards the conversation data to the server computer 12 in response to the search query (procedure 5026). The user device 18-1 then receives the conversation data for the GOI from the server computer 12 (procedure 5028). In this manner, the user device 18-1 obtains the updated conversation data for the GOI. Note that, in this embodiment, the conversation data is specifically for the GOI. Thus, filtering of the conversation data may not be necessary.

In this embodiment, one or more visual indicators are to be overlaid on the map being presented by the map client 26-1. The user device 18-1, through the map client 26-1, may determine positions on the map for the one or more visual indicators based on the conversation data for the GOI (procedure 5030). Based on the positions determined for the one or more visual indicators, the one or more visual indicators are overlaid by the user device 18-1 on the map to present the one or more visual indicators (procedure 5032).

Accordingly, as shown by procedures 5016, 5028, and 5032 in FIG. 6D, the user device 18-1 implements one embodiment of the exemplary procedures discussed above in FIG. 3. Procedure 5028 in FIG. 6D is one implementation of the exemplary procedure 1000 in FIG. 3, procedure 5016 in FIG. 6D is one implementation of exemplary procedure 1002 in FIG. 3, and procedure 5032 in FIG. 6D corresponds to one implementation of exemplary procedure 1004 in FIG. 3. Procedure 5016 is initiated first, procedure 5028 is initiated second, and procedure 5032 is initiated third. Thus, in this embodiment, one embodiment of the exemplary procedure 1002 is initiated first, one embodiment of the exemplary procedure 1000 is initiated second, and one embodiment of the exemplary procedure 1004 is initiated third.

Next, the user device 18-1 updates the location data for a current location of the user device 18-1 (procedure 5034), through the location client 24-1. The location client 24-1 forwards the updated location data to the map client 26-1. In this example, this current location of the user device 18-1 is the updated location of interest. Afterward, the user device 18-1 generates the map data request for updated map data (procedure 5036). The map data request includes the updated location data indicating the current location of the user device 18-1 and one or more map parameters that define the GOI. These one or more map parameters may also have been updated. For example, the user device 18-1 may have adjusted a zoom for the map thus updating the one or more map parameters in accordance with the adjusted zoom. The map data request is sent from the user device 18-1 to the server computer 12 (procedure 5038).

Upon receiving the map data request, the map server application 44 reads the map data request, which includes the updated location data and the one or more map parameters that define an updated GOI. The map server application 44 then formulates a search query to the database 14 for updated map data that corresponds to the updated GOI based on the updated location data and the one or map parameters that define the updated GOI (procedure 5040). Next, the search query is then forwarded from the server computer 12 to the database 14 (procedure 5042). The database 14 finds the relevant map data records that correspond to the updated map data for the updated GOI. The database 14 then forwards the updated map data to the server computer 12 in response to the search query (procedure 5044). The user device 18-1 then receives the updated map data from the server computer 12 (procedure 5046). Note that, in this embodiment, the updated map data is specifically for the updated GOI. The user device 18-1 presents an updated map of the updated GOI based on the updated map data (procedure 5048).

Next, the user device 18-1 generates the conversation data request for updated conversation data (procedure 5050). The conversation data request includes the updated location data indicating the current location of the user device 18-1 and one or more map parameters that define the updated GOI. The conversation data request is sent from the user device 18-1 to the server computer 12 (procedure 5052).

Upon receiving the conversation data request, the map server application 44 reads the conversation data request, which includes the updated location data and the one or more map parameters that define the updated GOI. The map server application 44 then formulates a search query to the database 14 for conversation data that corresponds to the updated GOI based on the updated location data and the one or more map parameters that define the GOI (procedure 5054). Next, the search query is then forwarded from the server computer 12 to the database 14 (procedure 5056). The database 14 finds the relevant map data records or the conversation data records having the updated conversation data for the GOI. The database 14 then forwards the conversation data to the server computer 12 in response to the search query (procedure 5058). The user device 18-1 then receives the updated conversation data for the GOI from the server computer 12 (procedure 5060). In this manner, the user device 18-1 obtains the updated conversation data for the GOI. The user device 18-1, through the map client 26-1, may determine updated positions on the map for the one or more visual indicators based on the conversation data for the updated GOI (procedure 5062). In addition or alternatively, new positions for one or more new visual indicators may be determined if there is conversation data for new conversations. Based on the updated positions determined for the one or more visual indicators, the one or more visual indicators are overlaid by the user device 18-1 on the updated map to present the one or more updated visual indicators (procedure 5064). In addition or alternatively, the updated map may also have the one or more new visual indicators.

Accordingly, as shown by procedures 5048, 5060, and 5064 in FIG. 6D, the user device 18-1 implements another embodiment of the exemplary procedures discussed above in FIG. 3. Procedure 5060 in FIG. 6D is one implementation of the exemplary procedure 1000 in FIG. 3, procedure 5048 in FIG. 6D is one implementation of exemplary procedure 1002 in FIG. 3, and procedure 5064 in FIG. 6D corresponds to one implementation of exemplary procedure 1004 in FIG. 3. Procedure 5048 is initiated first, procedure 5060 is initiated second, and procedure 5064 is initiated third. Thus, in this embodiment, one embodiment of the exemplary procedure 1002 is initiated first, one embodiment of the exemplary procedure 1000 is initiated second, and one embodiment of the exemplary procedure 1004 is initiated third.

FIG. 6E illustrates embodiments of the exemplary procedures described above in FIG. 3 and other related exemplary procedures. To begin, the user device 18-1 initiates the location client 24-1 and the map client 26-1 (procedure 6000). The map client 26-1 may provide the GUI with a search bar that allows the user 20-1 to provide user input. The user input from the search bar may be utilized to find map data for the geographic region related with the user input. For example, user input, such as “Los Angeles,” may be entered to find map data related to the city of Los Angeles. The user device 18-1 obtains the user input from the search bar (procedure 6002). The user device 18-1 may then generate the map data request that includes the user input (procedure 6004). The map data request is then sent from the user device 18-1 to the server computer 12 (procedure 6006).

Next, the map server application 44 may formulate a search query based on the user input (procedure 6008). The search query is then forwarded to the database 14 (procedure 6010). The search query has been formulated so that the database 14 searches the map data records to find map data related to the user input. For instance, if the user input was “Los Angeles,” the search query causes the database 14 to search through data tables to see if any map data records are associated with “Los Angeles.” In this example, the database 14 may find the map data records corresponding to the city of Los Angeles. The database 14 may extract the map data from the relevant map data records. Once the map data is extracted, the map data is forwarded to the server computer 12 (procedure 6012). The user device 18-1 then receives the map data from the server computer (procedure 6014).

A map of the geographic region is presented by the user device 18-1 (procedure 6016). Initially, the map may visually represent the geographic region. For example, the GUI of the map client 26-1 may initially represent the city of Los Angeles panned out from a great distance so that the city of Los Angeles is illustrated as the location in the state of California. The user device 18-1 may navigate through the map data using the map client 26-1 until the map of the GOI is presented (procedure 6018). Thus, the user 20-1, through manipulation of the GUI, may cause the map client 26-1 to zoom the map in and out. Once zoomed in or out, the user 20-1 may focus the map on the visual representations of different geographic portions of Los Angeles. This may involve continuous updates and filtering of the map data so that the map is updated as the zoom and focus of the map is changed by the user 20-1.

When the GOI is presented on the map, the user 20-1 may select a virtual button on the GUI or the like. The user device 18-1 may retrieve the location data indicating for a location of interest. In this example, the location of interest may be determined as the location currently being visually represented on the map. For instance, the user 20-1 may be interested in conversations currently occurring around Los Angeles Memorial Coliseum, which is within the city of Los Angeles. Once the map visually represents the geographic area that includes Los Angeles Memorial Coliseum, the user 20-1 may select the virtual button on the GUI. In this manner, the GOI is the geographic area that includes Los Angeles Memorial Coliseum, which is currently being visually represented by the map client 26-1. The user device 18-1 may retrieve location data indicating a location of interest (procedure 6020). The location of interest may be a central location of the GOI. Location data indicating the central location of the GOI may be stored within the map data. The user device 18-1 may thus retrieve the location data by extracting the location data from the map data. Alternatively, the user device 18-1 may retrieve the location data using the location client 24-1.

Next, the user device 18-1 generates the conversation data request for conversation data (procedure 6022). The conversation data request includes the location data indicating the central location of the GOI and one or more map parameters that define the GOI. The conversation data request is sent from the user device 18-1 to the server computer 12 (procedure 6024).

Upon receiving the conversation data request, the map server application 44 reads the conversation data request, which includes the location data and the one or more map parameters that define the GOI. The map server application 44 then formulates a search query to the database 14 for conversation data that corresponds to the GOI based on the location data and the one or map parameters that define the GOI (procedure 6026). Next, the search query is forwarded from the server computer 12 to the database 14 (procedure 6028). The database 14 finds the relevant map data records or conversation data records having the conversation data for the GOI. The database 14 then forwards the conversation data to the server computer 12 in response to the search query (procedure 6030). The user device 18-1 then receives the conversation data for the GOI from the server computer 12 (procedure 6032). Note that the conversation data is specifically for the GOI. In this embodiment, one or more visual indicators are to be presented contemporaneously by the map client 26-1 with the map of the GOI (procedure 6034).

Accordingly, as shown by procedures 6018, 6032, and 6034 in FIG. 6E, the user device 18-1 implements one embodiment of the exemplary procedures discussed above in FIG. 3. Procedure 6032 in FIG. 6E is one implementation of the exemplary procedure 1000 in FIG. 3, procedure 6018 in FIG. 6E is one implementation of exemplary procedure 1002 in FIG. 3, and procedure 6034 in FIG. 6E corresponds to one implementation of exemplary procedure 1004 in FIG. 3. Procedure 6018 is initiated first, procedure 6032 is initiated second, and procedure 6034 is initiated third. Thus, in this embodiment, one embodiment of the exemplary procedure 1002 is initiated first, one embodiment of the exemplary procedure 1000 is initiated second, and one embodiment of the exemplary procedure 1004 is initiated third.

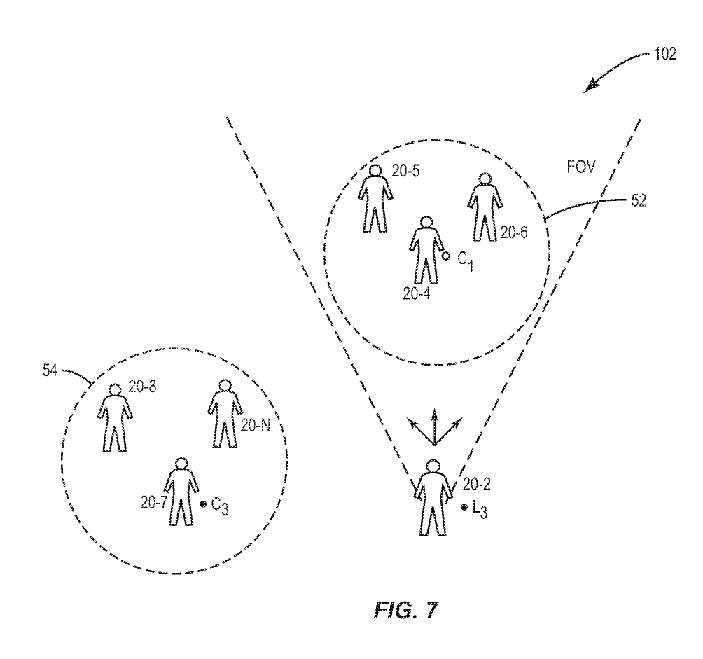

FIG. 7 pictorially illustrates an example of a GOI 102. In this embodiment, the GOI 102 is the real world physical geographic area being or to be represented on the viewfinder frame of the user device 18-2 associated with user 20-2. The user device 18-2 is a portable communication device that includes a camera. In this example, the user 20-2 and user device 18-2 are at a current location represented by L3. Thus, the camera may also be considered to be at location L3. The viewfinder frame of the GOI 102 is captured by the camera when the GOI 102 is within a field of view (FOV) of the camera.

At any given moment, the geographic area currently within the FOV of the camera depends on a current location of the camera, an orientation of the camera, and optical characteristics of the camera. The optical characteristics of the camera may or may not be adjustable by the user device 18-2. The FOV at any given moment may thus be described by the location data indicating the current location of the user device 18-2, orientation data describing the orientation of the camera, and at least one parameter that describes the optical characteristics of the camera. The location client 24-2 may be operable to obtain the location data indicating the current location of the user device 18-2. Furthermore, the user device 18-2 may include a gyroscope or the like. The viewfinder application 28-2 may be operable with the gyroscope to generate the orientation data indicating the orientation of the camera. The optical characteristics of the camera determine the size and dimensions of the FOV. These optical characteristics may be described by at least one FOV parameter for defining the FOV of the camera. Since the size and the dimensions of the FOV are determined by the optical characteristics of the camera, the at least one FOV parameter may also indicate a boundary of the GOI 102.

A visual representation of the GOI 102, in this case the viewfinder frame, is captured by the camera and presented utilizing the GUI application 36-2 of the viewfinder application 28-2. Note that the viewfinder application 28-2 may operate as a real-time application to present a stream of viewfinder frames sequentially in real-time. As the location and orientation of the camera change in real time, so may the geographic area visually represented by each of the viewfinder frames in the stream of viewfinder frames. As a result, the GOI may also change in real time. Note also that the optical characteristics of the camera may be adjustable and thus also modify the GOI.

As shown by FIG. 7, users 20-4 through 20-6 are within the GOI 102 and are currently engaged in a conversation within the geographic participation zone 52, such as the conversation described above for FIG. 2C. The location of the conversation is represented by C1. Users 20-4 through 20-6, the location C1, and the geographic participation zone 52 are within the FOV and thus the GOI 102, when the camera captures the viewfinder frame. Users 20-7 through users 20-N are currently engaged in a conversation, as described above for FIG. 2D, within the geographic participation zone 54. The location of the conversation is represented by C3. In this example, neither the users 20-7 through users 20-N, the location C3, nor the geographic participation zone 54 are within the FOV, and thus are not within the GOI 102.

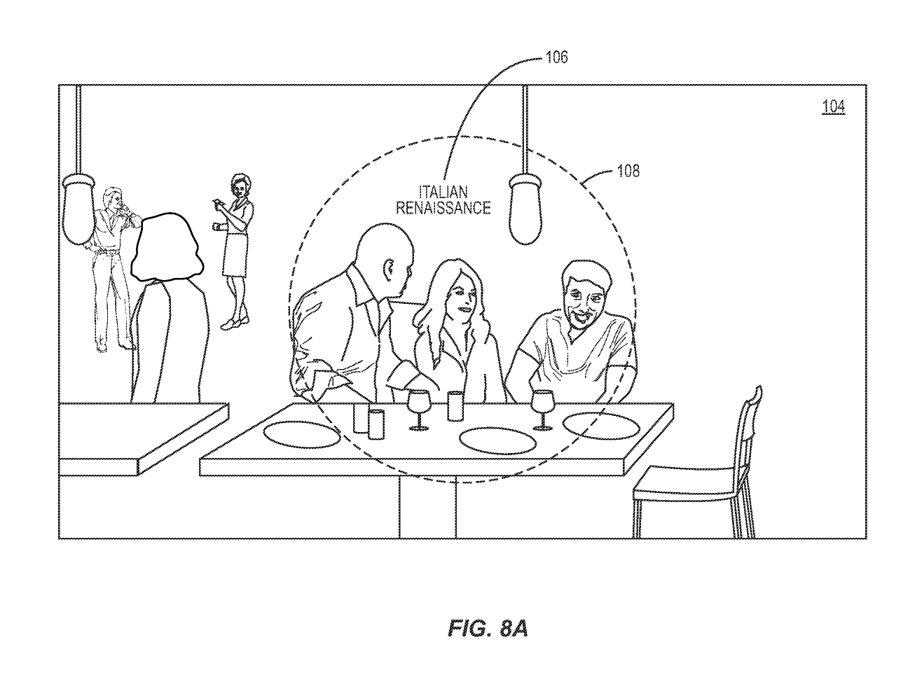

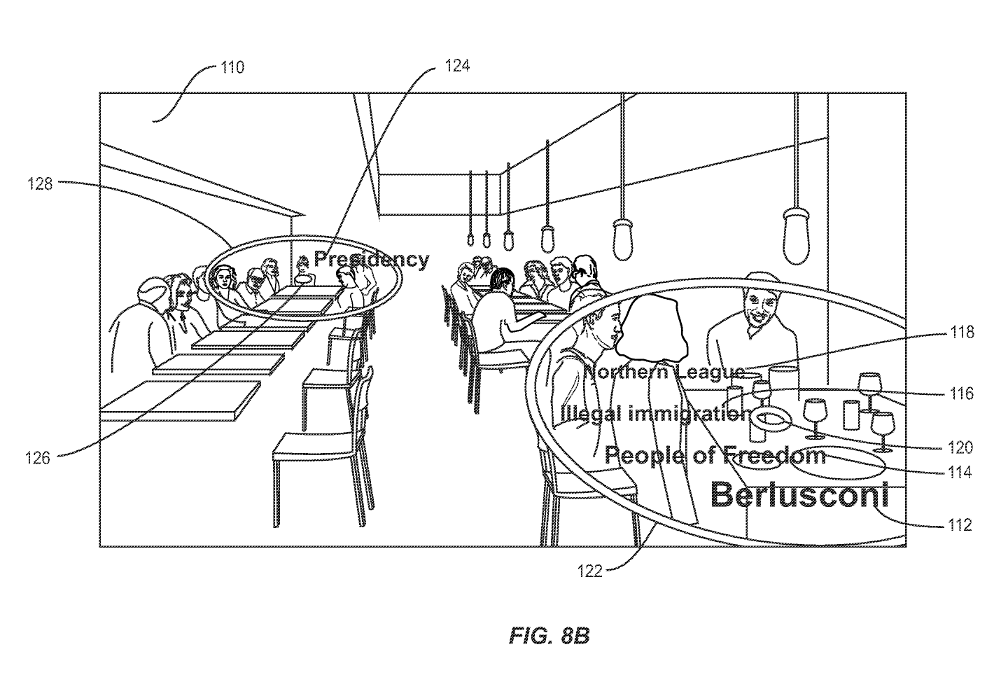

FIG. 8A illustrates one embodiment of a viewfinder frame 104 that visually represents the GOI 102 (shown in FIG. 7) and captured by the camera of the user device 18-2. The viewfinder frame 104 is being presented in association with a visual indicator 106 and a visual indicator 108 on a GUI provided by the GUI application 36-2 of the viewfinder application 28-2. In this example, the visual indicator 106 and the visual indicator 108 are presented in association with the viewfinder frame 104 by being overlaid on the viewfinder frame 104. Alternatively, the visual indicators may be presented in association with the viewfinder frame 104 by being presented contemporaneously with the viewfinder frame 104, similar to the maps described in FIGS. 5D and 5E, or by actually modifying pixel data or the like in the viewfinder frame.

The visual indicator 106 is based on the conversation data for the conversation currently occurring at location C1 (shown in FIG. 7) within the GOI 102 (shown in FIG. 7). The visual indicator 106 is positioned on the viewfinder frame 104 so as to represent the location C1 of the conversation. The position of the visual indicator 106 may be based on the location data that indicates the location C1 of the conversation, orientation data describing the orientation of the camera, and at least one FOV parameter for defining the FOV. The visual indicator 106 in FIG. 8A also simultaneously represents the topic of the conversation. In particular, the visual indicator 106 is presented as the textual representation of the topic of the conversation. The textual representation in this particular example reads “Italian Renaissance.” The conversation data may include keyword(s) or user input, as described above, indicating the topic for the conversation. The visual indicator 108 is also based on the conversation data for the conversation. The visual indicator 108 represents a boundary of the geographic participation zone 52 (shown in FIG. 7). The visual indicator 108 may be determined based on the location data that indicates the location C1, the orientation data describing the orientation of the camera, at least one FOV parameter for defining the FOV, and at least one parameter that defines the geographic participation zone 52, such as the radial parameter.

FIG. 8B illustrates one embodiment of another viewfinder frame 110 that visually represents a GOI after the current location and the orientation of the camera have been changed relative to the GOI 102 in FIG. 8A. Furthermore, the optical characteristics of the camera have been adjusted. For example, the user 20-2 may have moved the user device 18-2 to another location, changed the orientation of the camera, and adjusted the zoom of the camera. As a result, the GOI visually represented by the viewfinder frame 110 is different than the GOI 102 visually represented by viewfinder frame 104 in FIG. 8A. The viewfinder frame 110 is being presented on the GUI of the viewfinder application 28-1 in association with a visual indicator 112, a visual indicator 114, a visual indicator 116, a visual indicator 118, a visual indicator 120, a visual indicator 122, a visual indicator 124, a visual indicator 126, and a visual indicator 128. The visual indicator 112, the visual indicator 114, the visual indicator 116, the visual indicator 118, the visual indicator 120, the visual indicator 122, and the visual indicator 124 are based on the conversation data for the conversation currently occurring at location C1 (shown in FIG. 7). The visual indicator 112, the visual indicator 114, the visual indicator 116, and the visual indicator 118 are each textual representations of different topics of the conversation at location C1. Note that the visual indicator 112, the visual indicator 114, the visual indicator 116, and the visual indicator 118, each represent topics that are different than the topic represented by visual indicator 106 in FIG. 8A. Thus, the topic of the conversation at location C1 has changed and the conversation data for the conversation has been updated. This may be due to changes in the keyword(s) as the conversation progresses. The visual indicator 120 is a location marker that represents the location C1 of the conversation. The visual indicator 122 represents a boundary of the geographic participation zone 52.

In this example, the users 20-7 through users 20-N, the location C3 (shown in FIG. 7), and the geographic participation zone 54 are also within the FOV of the camera when the viewfinder frame was captured by the camera. The visual indicator 124 is a textual representation of the topic of the conversation at location C3. The visual indicator 126 is a location marker that represents the location C3. The visual indicator 128 represents a boundary of the geographic participation zone 52.

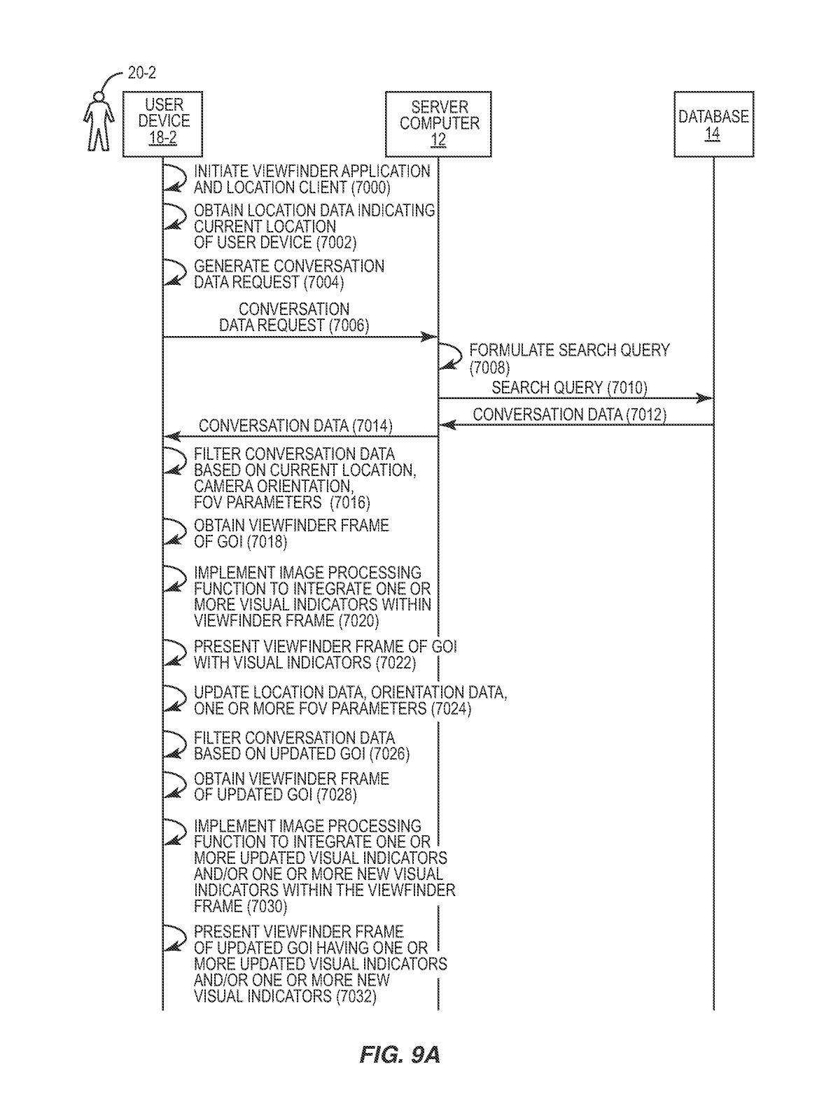

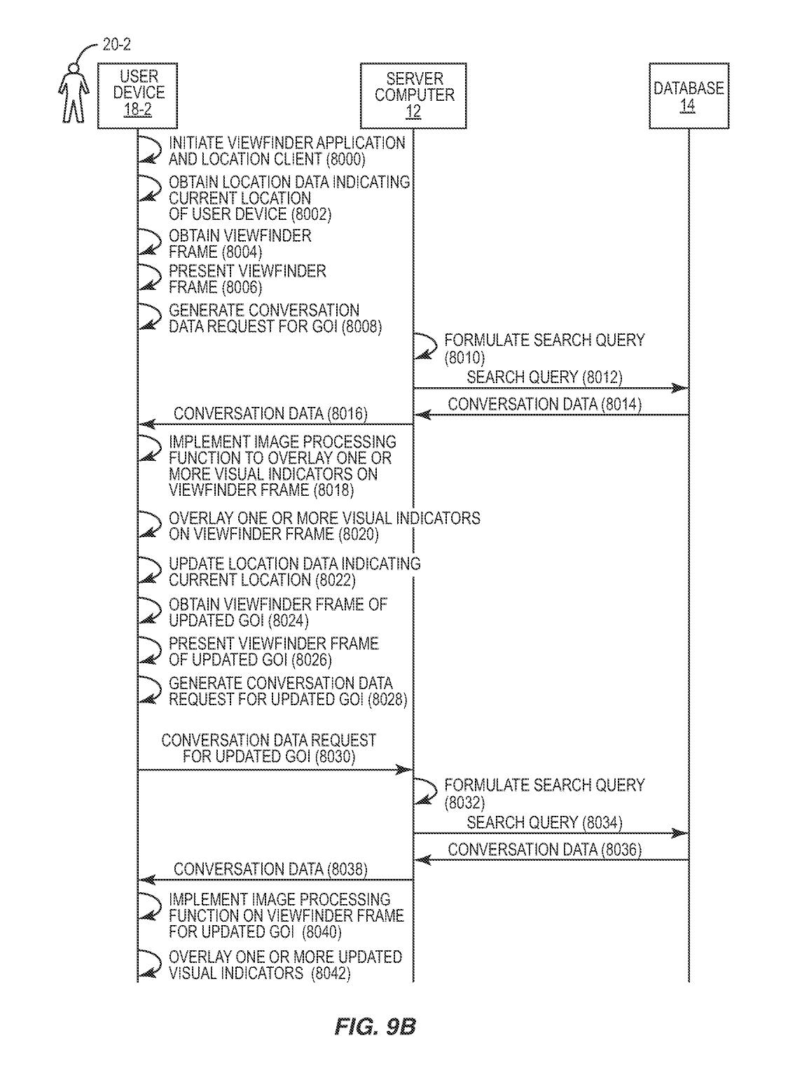

FIG. 9A illustrates embodiments of the exemplary procedures described above in FIG. 3 and other related exemplary procedures. To begin, the user device 18-2 initiates the viewfinder application 28-2 and the location client 24-2 (procedure 7000). For example, the user 20-1 may utilize a GUI on the user device 18-2 to select a viewfinder icon or the like that when selected initiates the viewfinder application 28-2. This in turn, may automatically initiate the location client 24-2 simultaneously with, concurrently with, and/or as part of the viewfinder application 28-2. Alternatively, user device 18-2 may initiate the location client 24-2 and the viewfinder application 28-2 separately. For example, after the viewfinder application icon has been selected by the user 20-2, the user device 18-2 may simply wait until the viewfinder application 28-2 has been fully initiated to automatically initiate the location client 24-2. In still another alternative, the user 20-2 may select a separate location client application icon or the like that when selected initiates the location client 24-2. The particular manner that the user device 18-2 initiates the location client 24-2 and the viewfinder application 28-2 may depend on the particular implementation of location client 24-2 and the viewfinder application 28-2 provided by the user device 18-2 as well as other technical features and characteristics of the user device 18-2.

Next, the user device 18-2 obtains location data indicating a current location of the user device 18-2 using the location client 24-2 (procedure 7002). In this embodiment, the current location of the user device 18-2 is the location of interest. Afterward, the user device 18-2 generates a conversation data request for map data (procedure 7004). The conversation data request includes the location data indicating the current location of the user device 18-2. The conversation data request is sent from the user device 18-2 to the server computer 12 (procedure 7006).

Upon receiving the conversation data request, the map server application 44 reads the conversation data request, which includes the location data. The map server application 44 then formulates a search query to the database 14 for conversation data that corresponds to a geographic area surrounding the current location indicated by the location data (procedure 7008). In this embodiment, the map server application 44 may not have sufficient information to determine a GOI for a viewfinder frame. Nevertheless, the geographic area surrounding the location of interest (in this case, the current location of the user device 18-1) may be large enough so that it necessarily includes any GOI that could be visually represented by a viewfinder frame on the user device 18-2. For example, the user device 18-2 may pre-download conversation data corresponding to a large geographic area to avoid overly repetitive updates. Due to the size of the geographic area, the geographic area surrounding the location of interest must necessarily be greater than and include a GOI that is to be visually represented on the viewfinder frame. As a result, the conversation data for the geographic area surrounding the location of interest also has to include the conversation data for the GOI.

Next, the search query is forwarded from the server computer 12 to the database 14 (procedure 7010). The database 14 finds the relevant conversation data in the map data records or conversation data records that correspond to the geographic area surrounding the location of interest, which in this case is the current location of the user device 18-2. The database 14 then forwards the conversation data to the server computer 12 (procedure 7012).

Next, the user device 18-2 then receives the conversation data from the server computer 12 (procedure 7014). As a result, the user device 18-2 obtains the map data and conversation data. The conversation data includes the conversation data for a GOI, as mentioned above. In this embodiment, the map data for a GOI may need to be identified from the conversation data for the geographic area surrounding the location of interest prior to presenting the viewfinder frame. To identify conversation data for a GOI, the conversation data for the geographic area surrounding the current location may be filtered based on the current location of the user device, as indicated by the location data, an orientation of the camera, and at least one FOV parameter that defines a boundary of a GOI represented by the viewfinder frame (procedure 7016). The user device 18-2 may then obtain the viewfinder image of the GOI (procedure 7018).

In this embodiment, one or more visual indicators are to be overlaid on the viewfinder frame. The user device 18-2 may implement the image processing function 32-2 to integrate the one or more visual indicators within the viewfinder frame on the viewfinder application (procedure 7020). The image processing function 32-2 may integrate the one or more visual indicators into the viewfinder frame by adjusting the pixel values of the viewfinder frame. For example, the image processing function 32-2 may be operable to generate a mask based on the identified conversation data, the location data, the orientation data, and one or more FOV parameters. When the image processing function 32-2 processes the viewfinder frame with the mask, pixel values of the viewfinder frame are modified so that the one or more visual indicators are presented on the viewfinder frame. In this manner, the one or more visual indicators are presented on the viewfinder frame to represent the identified conversation data. The user device 18-2 then presents the viewfinder frame of the GOI with the one or more visual indicators (procedure 7022). The viewfinder frame of the GOI may be presented through the GUI application 36-2 of the viewfinder application 28-2. Note that, in this case, both presenting the viewfinder frame and presenting the one or more visual indicators on the viewfinder frame occurs simultaneously.

Accordingly, as shown by procedures 7014 and 7022 in FIG. 9A, the user device 18-2 implements one embodiment of the exemplary procedures discussed above in FIG. 3. Procedure 7014 in FIG. 9A is one implementation of the exemplary procedure 1000 in FIG. 3, and procedure 7022 in FIG. 9A is one implementation of both exemplary procedures 1002 and 1004 in FIG. 3. Procedure 7014 is initiated first and procedure 7022 is initiated later. Thus, in this embodiment, one embodiment of the exemplary procedure 1000 is initiated first, and one embodiment of the exemplary procedures 1002 and exemplary procedure 1004 occur simultaneously.

Next, the location client 24-2 may provide updated location data indicating an updated current location of the user device 18-2 (procedure 7024). The updated location data may be forwarded to the viewfinder application 28-2. To identify conversation data for an updated GOI, the conversation data for the geographic area surrounding the prior current location may be filtered based on an updated GOI (procedure 7026). For example, the conversation data for the geographic area surrounding the prior current location may be filtered based on the updated current location of the user device, as indicated by the updated location data, an updated orientation, and at least one FOV parameter. The user device 18-2 may obtain a viewfinder frame visually representing an updated GOI (procedure 7028).

The user device 18-2 may implement the image processing function to integrate one or more updated visual indicators on the viewfinder frame of the updated GOI (procedure 7030). In addition or alternatively, one or more new visual indicators may be integrated within the viewfinder frame based on the conversation data for the updated GOI. The user device 18-2 then presents the viewfinder frame of the updated GOI with the one or more updated visual indicators and/or any new visual indicators (procedure 7032). The viewfinder frame of the updated GOI may be presented through the GUI application 36-2 of the viewfinder application 28-2.

Accordingly, as shown by procedure 7014 and 7032 in FIG. 9A, the user device 18-2 implements another embodiment of the exemplary procedures discussed above in FIG. 3. Procedure 7014 in FIG. 9A is one implementation of the exemplary procedure 1000 in FIG. 3, and procedure 7032 in FIG. 9A is one implementation of both exemplary procedures 1002 and 1004 in FIG. 3. Procedure 7014 is initiated first and procedure 7032 is initiated later. Thus, in this embodiment, one embodiment of the exemplary procedure 1000 is initiated first, and one embodiment of the exemplary procedures 1002 and exemplary procedure 1004 occur simultaneously.

FIG. 9B illustrates embodiments of the exemplary procedures described above in FIG. 3 and other related exemplary procedures. To begin, the user device 18-2 initiates the location client 24-2 and the viewfinder application 28-2 (procedure 8000). Next, the user device 18-2 obtains location data indicating a current location of the user device 18-2 using the location client 24-2 (procedure 8002). In this example, the current location of the user device 18-2 is the location of interest. The user device 18-2 obtains the viewfinder frame visually representing a GOI (procedure 8004). Once the viewfinder frame is obtained, the viewfinder application 28-2 presents the viewfinder frame (procedure 8006). The user device 18-2 then generates a conversation data request for conversation data (procedure 8008). The conversation data request is specifically for the GOI. Thus, the conversation data request includes the location data indicating the current location of the user device 18-2, orientation data indicating an orientation of the user device 18-2, and at least one FOV parameter for defining the GOI. The conversation data request is sent from the user device 18-1 to the server computer 12 (procedure 8009).

Upon receiving the conversation data request, the map server application 44 reads the conversation data request, which includes the location data, the orientation data, and the at least one FOV parameter. The map server application 44 then formulates a search query to find conversation data specifically for the GOI (procedure 8010). Next, the search query is forwarded from the server computer 12 to the database 14 (procedure 8012). The database 14 finds the relevant map data records or conversation data records that correspond to the conversation data for the GOI. The database 14 then forwards the conversation data to the server computer 12 in response to the search query (procedure 8014). The user device 18-2 then receives the conversation data from the server computer 12 (procedure 8016). Note that, in this embodiment, the conversation data is specifically for the GOI. Thus, filtering of the conversation data may not be necessary.

The user device 18-2 may implement the image processing function 32-2 to overlay one or more updated visual indicators on the viewfinder frame of the updated GOI (procedure 8018). The image processing function 32-2 may overlay the one or more visual indicators based on the identified conversation data, location data indicating the current location of the user device 18-2, orientation data indicating an orientation of the user device 18-2, and one or more FOV parameters for defining the FOV (procedure 8020). In this manner, the user device 18-2 presents the one or more visual indicators with the viewfinder frame.

Accordingly, as shown by procedures 8006, 8016, and 8020 in FIG. 9B, the user device 18-2 implements another embodiment of the exemplary procedures discussed above in FIG. 3. Procedure 8016 in FIG. 9B is one implementation of the exemplary procedure 1000 in FIG. 3, procedure 8006 in FIG. 9B is one implementation of exemplary procedure 1002 in FIG. 3, and procedure 8020 in FIG. 9B corresponds to one implementation of exemplary procedure 1004 in FIG. 3. Procedure 8006 is initiated first, procedure 8016 is initiated second, and procedure 8020 is initiated third. Thus, in this embodiment, one embodiment of the exemplary procedure 1002 is initiated first, one embodiment of the exemplary procedure 1000 is initiated second, and one embodiment of the exemplary procedure 1004 is initiated third.

In this embodiment, the user device only receives the conversation data for the GOI. However, the user 20-2 may continuously be changing the location and orientation of the user device 18-1 and may operate the camera control function 30-2 to change the optical characteristics of the camera. Augmented reality may be provided by requesting regular updates of conversation data. To do this, the user device 18-2 obtains location data indicating an updated current location of the user device 18-2 using the location client 24-2 (procedure 8022). The user device 18-2 obtains the viewfinder frame visually representing an updated GOI (procedure 8024). Once the viewfinder frame is obtained, the viewfinder application 28-2 presents the viewfinder frame for the updated GOI (procedure 8026). The user device 18-2 then generates a conversation data request for conversation data (procedure 8028). The conversation data request is specifically for the updated GOI. Thus, the conversation data request includes the updated location data indicating the current location of the user device 18-2, updated orientation data indicating an orientation of the user device 18-2, and at least one FOV parameter for defining the GOI. The conversation data request is then sent from the user device 18-1 to the server computer 12 (procedure 8030).

Upon receiving the conversation data request, the map server application 44 reads the conversation data request, which includes the updated location data, the updated orientation data, and the at least one FOV parameter. The map server application 44 then formulates a search query to find conversation data specifically for the updated GOI (procedure 8032). Next, the search query is forwarded from the server computer 12 to the database 14 (procedure 8034). The database 14 finds the relevant map data records or conversation data records that correspond to the conversation data for the updated GOI. The database 14 forwards the conversation data to the server computer 12 in response to the search query (procedure 8036). The user device 18-2 then receives the conversation data for the updated GOI from the server computer 12 (procedure 8038). Note that, in this embodiment, the conversation data is specifically for the updated GOI.

The user device 18-2 may implement the image processing function 32-2 to overlay one or more updated visual indicators on the viewfinder frame for the updated GOI (procedure 8040). The image processing function 32-2 overlays the one or more updated visual indicators (procedure 8042) based on the conversation data for the GOI, updated location data indicating the current location of the user device 18-2, updated orientation data indicating an orientation of the user device 18-2, and one or more FOV parameters for defining the FOV. In this manner, the user device 18-2 presents the one or more updated visual indicators with the viewfinder frame for the updated GOI. Additionally or alternatively, one or more new visual indicators may be overlaid on the viewfinder frame, if there is conversation data for new conversations.

Accordingly, as shown by procedures 8026, 8038, and 8042 in FIG. 9B, the user device 18-2 implements another embodiment of the exemplary procedures discussed above in FIG. 3. Procedure 8038 in FIG. 9B is one implementation of the exemplary procedure 1000 in FIG. 3, procedure 8026 in FIG. 9B is one implementation of exemplary procedure 1002 in FIG. 3, and procedure 8042 in FIG. 9B corresponds to one implementation of exemplary procedure 1004 in FIG. 3. Procedure 8026 is initiated first, procedure 8038 is initiated second, and procedure 8042 is initiated third. Thus, in this embodiment, one embodiment of the exemplary procedure 1002 is initiated first, one embodiment of the exemplary procedure 1000 is initiated second, and one embodiment of the exemplary procedure 1004 is initiated third.

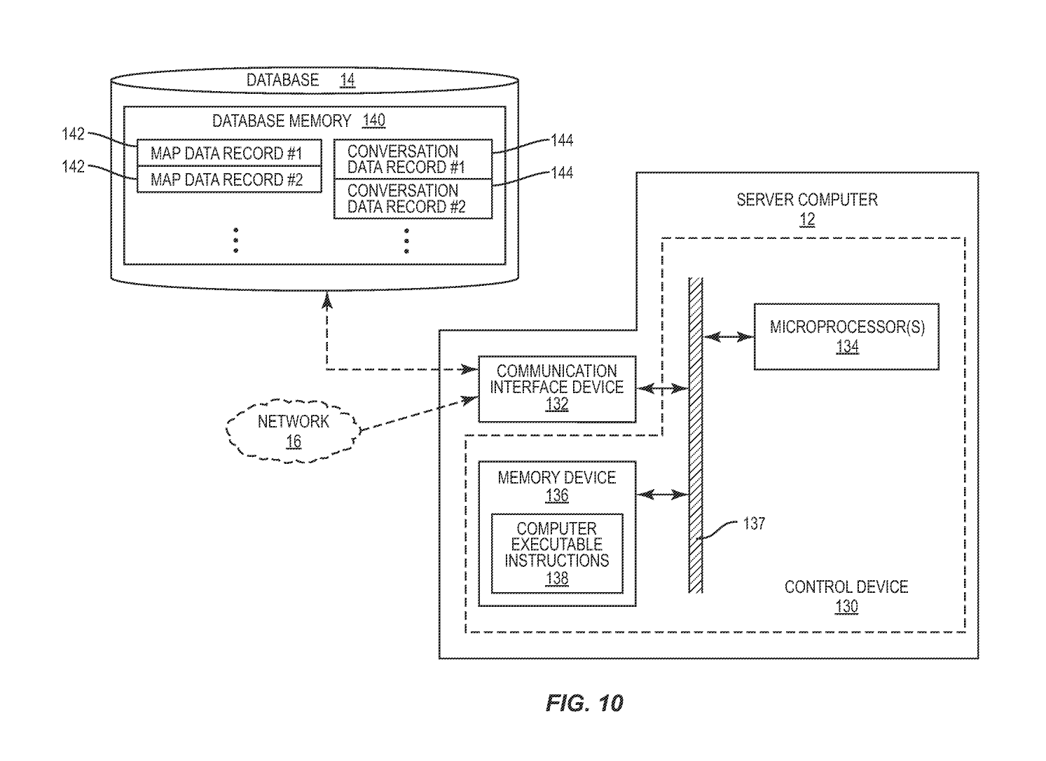

FIG. 10 illustrates one embodiment of the server computer 12 shown in FIG. 1. The server computer 12 includes a control device 130 and a communication interface device 132. The database 14 connects to the server computer 12 through communication interface device 132. The communication interface device 132 also is operable to communicatively couple the server computer 12 to the network 16. As discussed above, network 16 may include various different types of networks. The communication interface device 132 is adapted to facilitate communications with one or more communication services on the network 16. In this example, the communication interface device 132 may facilitate communications for any number of communication services provided by mobile communications networks, packet-switched networks, circuit switched networks, and/or the like.

In this embodiment, the control device 130 has general purpose computer hardware, in this case one or more microprocessors 134, and a non-transitory computer readable medium, such as a memory device 136, and a system bus 137. The control device 130 may also include other hardware such as, control logic, other processing devices, additional non-transitory computer readable mediums, and the like. User input and output devices (not shown), such as monitors, keyboards, mouse, touch screens, and the like may also be provided to receive input and output information from a server administrator. The memory device 136 may store computer executable instructions 138 for execution by the microprocessors 134. The computer executable instructions 138 are executable by the microprocessors 134 and configure the operation of the microprocessors 134 so that the microprocessors 134 implement the software applications for the server computer 12 discussed above. A system bus 137 is operably associated with the microprocessors 134 so that microprocessors 134 can exchange information between the control device 130, the memory device 136, and the communication interface device 132 and other hardware components internal to the server computer 12.

The database 14 includes database memory 140 to store map data records 142 and conversation data records 144. The database 14 may include additional stored information, such as database tables in local memory. Furthermore, the database 14 may include additional programmed hardware components (not shown) that allow for the creation, organization, retrieval, updating, and/or storage of map data records 142 and conversation data records 144.

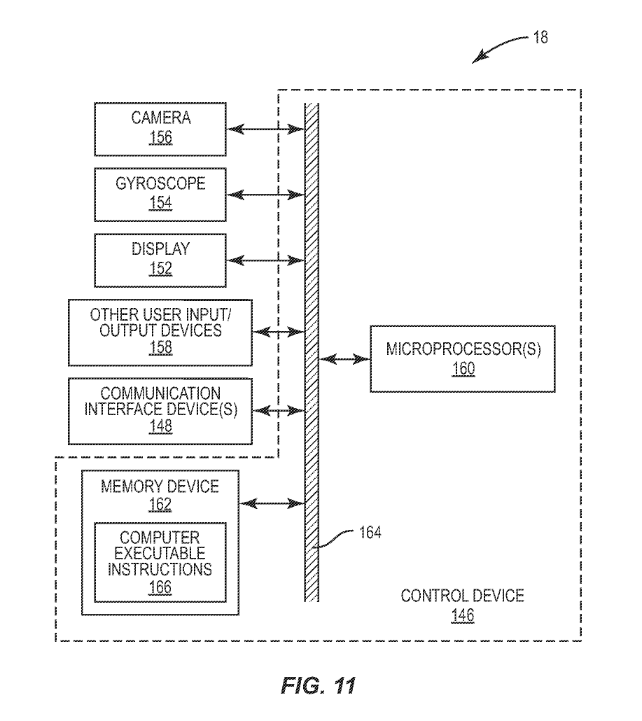

FIG. 11 illustrates one embodiment of the user device 18, which may be any of the user devices 18-1 through 18-N shown in FIG. 1. The user device 18 includes a control device 146, a communication interface device 148, a display 152, a gyroscope 154, a camera 156, and other user input and output devices 158. Communication interface device 148 is operable to communicatively couple the user device 18 to the network 16. As discussed above, network 16 may include various different types of networks. The communication interface device 148 is adapted to facilitate communications with one or more communication services on the network 16. In this example, the communication interface device 148 may facilitate communications for any number of communication services provided by mobile communications networks, packet-switched networks, circuit switched networks, and/or the like.

In this embodiment, the control device 146 has general purpose computer hardware, in this case one or more microprocessors 160, a non-transitory computer readable medium, such as memory device 162, and a system bus 164. The system bus 164 is operably associated with the microprocessors 160 so that microprocessors 160 can exchange information with the communication interface device 148, the display 152, the gyroscope 154, the camera 156, and other user input and output devices 158. The control device 146 may also include other hardware such as, control logic, other processing devices, additional non-transitory computer readable mediums, and the like. The memory device 162 may store computer executable instructions 166 for execution by the microprocessors 134. The computer executable instructions 166 configure the operation of the microprocessors 160 so that the microprocessors 160 implement the software applications for the user device 18 discussed above.

The display 152 may be any suitable display suitable for the presentation of visual representations of the GOI, such as maps or viewfinder frames. For example, the display 152 may be a touch screen, a monitor, a television, an LCD display, a plasma display, and/or the like. The gyroscope 154 is operable to allow the user device 18 to determine, measure, and/or detect an orientation of the user device 18. In addition, the camera 156 is operable with the viewfinder application 28 to capture streams of viewfinder frames. Other embodiments of the camera 156 may be operable to capture other types of visual representations of a GOI. The other user input and output devices 158 may be a keyboard, a microphone, a head-set, a mouse, and/or an input button, and may depend on the particular configuration of the user device 18.

Those skilled in the art will recognize improvements and modifications to the preferred embodiments of the present disclosure. All such improvements and modifications are considered within the scope of the concepts disclosed herein and the claims that follow.

What is claimed is:

1. A method, comprising:
obtaining, by a user device, conversation data for a geographic area of interest, the conversation data indicating a topic for a conversation currently occurring within the geographic area of interest and a location of the conversation within the geographic area of interest;
presenting a visual representation of the geographic area of interest by the user device; and
presenting at least one visual indicator in association with the visual representation of the geographic area of interest, the at least one visual indicator representing the topic of the conversation and the location of the conversation.

2. The method of claim 1, wherein presenting the at least one visual indicator in association with the visual representation of the geographic area of interest comprises presenting a first visual indicator that is positioned on the visual representation so as to indicate the location of the conversation within the geographic area of interest.

3. The method of claim 2, wherein presenting the first visual indicator comprises presenting the first visual indicator as a textual representation of the topic.

4. The method of claim 2, wherein presenting the at least one visual indicator in association with the visual representation of the geographic area of interest comprises:
presenting the first visual indicator as a location marker on the visual representation; and
presenting a second visual indicator as a textual representation of the topic wherein the second visual indicator is presented so as to indicate an association between the first visual indicator and the second visual indicator.

5. The method of claim 4, wherein the second visual indicator is presented on the visual representation adjacent to the first visual indicator.

6. The method of claim 2, wherein:
presenting the visual representation of the geographic area of interest comprises presenting a map of the geographic area of interest by the user device; and
wherein presenting the first visual indicator comprises:
determining a position on the map for the first visual indicator based on the conversation data so that the position on the map corresponds to the location of the conversation; and
overlaying the first visual indicator on the map at the position.

7. The method of claim 2, wherein the user device comprises a portable communication device that includes a camera, wherein:
presenting the visual representation of the geographic area of interest comprises presenting a viewfinder frame captured by the camera of the geographic area of interest; and
presenting the first visual indicator comprises overlaying the first visual indicator at a position on the viewfinder frame that corresponds to the location of the conversation by implementing an image processing function based on the conversation data and at least one field of view parameter that defines a field of view of the camera.

8. The method of claim 1, wherein the at least one visual indicator includes a visual indicator that represents at least a boundary of a geographic conversation zone on the visual representation.

9. The method of claim 8, further comprising:
obtaining a keyword that indicates the topic of the conversation from the audio data of the conversation; and
wherein the conversation data for the geographic area of interest comprises the keyword to indicate the topic of the conversation.

10. The method of claim 9, further comprising:
moving the user device from outside the geographic conversation zone into the geographic conversation zone; and
in response to moving the user device into the geographic conversation zone, receiving, by the user device, an invitation to join the conversation from a server computer.

11. The method of claim 1, wherein the conversation data comprises:
one of either a keyword that indicates a topic of the conversation and has been extracted from audio data resulting from the conversation or user input that indicates a topic of the conversation; and
one of either global position system data that indicates the location of the conversation or triangulation data that indicates the location of the conversation.

12. The method of claim 1, wherein presenting the visual representation of the geographic area of interest is initiated before presenting the at least one visual indicator.

13. The method of claim 1, wherein presenting the visual representation of the geographic area of interest is initiated simultaneously with presenting the at least one visual indicator in association with the visual representation of the geographic area of interest.

14. The method of claim 1, further comprising:
sending, to a server computer, a conversation data request from the user device; and
wherein obtaining the conversation data for the geographic area of interest from the server computer comprises:
receiving, by the user device, conversation data from the server computer in response to the conversation data request, wherein the conversation data from the server computer at least includes conversation data for the geographic area of interest.

15. The method of claim 14, further comprising:
sending, to the server computer, a map data request from the user device;
receiving, by the user device, map data from the server computer in response to the map data request that at least includes map data for the geographic area of interest; and
wherein presenting the visual representation of the geographic area of interest by the user device comprises presenting a map of the geographic area of interest in accordance with the map data for the geographic area of interest.

16. The method of claim 15, wherein presenting the map of the geographic area of interest occurs prior to obtaining the conversation data for the geographic area of interest.

17. The method of claim 14, wherein:
the conversation data request from the user device is also a map data request;
receiving the conversation data from the server computer in response to the conversation data request further comprises receiving map data from the server computer that at least includes the map data for the geographic area of interest; and
presenting the visual representation of the geographic area of interest by the user device comprises presenting a map of the geographic area of interest in accordance with the map data for the geographic area of interest.

18. The method of claim 17, wherein obtaining the conversation data for the geographic area of interest occurs prior to presenting the map.

19. The method of claim 14, wherein the conversation data request comprises location data that indicates a location of interest.

20. The method of claim 19, wherein the location of interest is a current location of the user device.

21. The method of claim 19, wherein the conversation data request further comprises at least one parameter that indicates the boundary of the geographic area of interest and wherein:
receiving the conversation data from the server computer in response to the conversation data request comprises only receiving the conversation data for the geographic area of interest.

22. The method of claim 21, wherein the visual representation comprises a map of the geographic area of interest and the at least one parameter comprises at least one map parameter that defines a boundary of the map.

23. The method of claim 21, wherein:
the user device is a portable communication device that includes a camera;
wherein presenting the visual representation of the geographic area of interest comprises presenting a viewfinder frame of the geographic area of interest captured by the camera; and
wherein the at least one parameter comprises at least one field of view parameter for defining a field of view of the camera.

24. The method of claim 19,
wherein the conversation data from the server computer comprises conversation data for a geographic area surrounding the location of interest such that the geographic area surrounding the location of interest is greater than and includes the geographic area of interest whereby the conversation data for the geographic area surrounding the location of interest includes the conversation data for the geographic area of interest;
wherein the method further comprises, prior to presenting the at least one visual indicator in association with the visual representation, identifying the conversation data for the geographic area of interest from the geographic area surrounding the location of interest; and
wherein the at least one visual indicator represents the identified conversation data for the geographic area of interest.

25. The method of claim 24, wherein identifying the conversation data for the geographic area of interest from the geographic area surrounding the location of interest comprises:
filtering the conversation data for the geographic area surrounding the location of interest based on the location of interest and at least one parameter that defines a boundary of the geographic area of interest.

26. The method of claim 25 wherein the visual representation comprises a map of the geographic area of interest and the at least one parameter comprises at least one map parameter that defines a boundary of the map.

27. The method of claim 25, wherein:
the user device is a portable communication device that includes a camera;
wherein presenting the visual representation of the geographic area of interest comprises presenting a viewfinder frame of the geographic area of interest captured by the camera; and
wherein the at least one parameter comprises at least one field of view parameter for defining a field of view of the camera.

28. A user device, comprising:
a communication interface device operable to communicatively couple the user device to a network; and
a control device operably associated with the communication interface device, wherein the control device is configured to:
obtain conversation data for a geographic area of interest from the server computer, the conversation data indicating a topic for a conversation currently occurring within the geographic area of interest and a location of the conversation within the geographic area of interest;
present a visual representation of the geographic area of interest; and
present at least one visual indicator in association with the visual representation of the geographic area of interest, the at least one visual indicator representing the topic of the conversation and the location of the conversation.

29. The user device of claim 28, wherein the visual representation is a map of the geographic area of interest.

30. The user device of claim 29, wherein the user device further comprises a camera and wherein the visual representation is a viewfinder frame captured by the camera.

31. A computer readable medium that stores computer executable instructions for execution by one or more microprocessors to cause a user device to implement a method, wherein the method comprises:
obtaining conversation data for a geographic area of interest, the conversation data indicating a topic for a conversation currently occurring within the geographic area of interest and a location of the conversation within the geographic area of interest;
presenting a visual representation of the geographic area of interest; and
presenting at least one visual indicator in association with the visual representation of the geographic area of interest, the at least one visual indicator representing the topic of the conversation and the location of the conversation.
